(19) United States
(12) Patent Application Publication
(10) Pub. No.: US 2002/0108507 A1
(43) Pub. Date: Aug. 15, 2002

(54) Interactive waste receptacle

(76) Inventors: Charlotte Mary-Anne May, Keswick (CA); Glenn Emile Rochone, Keswick (CA)

Correspondence Address: Oldham & Oldham Co., L.P.A., Twin Oaks Estate, 1225 West Market Street, Akron, OH, 44313-7188, US

(21) Appl. No.: 09/783,713

(22) Filed: Feb. 14, 2001

(51) Int. Cl. B30B 15/14

(52) U.S. Cl. 100/45; 100/49; 100/99; 700/229

(57) ABSTRACT

A refuse collection system includes a plurality of waste receptacles arrayed adjacent to, or in the midst of, an eating area. Some of the waste receptacles may include compactor elements, and others may not. The receptacles have electronic control units and sensors for detecting the presence of patrons adjacent to the refuse receiving inlet door, or chute, and to sense the quantity of refuse accumulated in the receptacle. The patron sensor employs a wide angled feature for better detection of patrons who approach the unit from and oblique angle. The units have signal conveying devices, such as loudspeakers, by which aural messages can be communicated to patrons or servicing personnel. The electronic control units are able to communicate to a remote monitoring location, whether a fixed station or a portable station carried by a staff member.

### FIELD OF THE INVENTION

This invention relates to structures for collecting refuse, such as may be used, for example, in a public eating area such as a fast-food restaurant or food court.

### BACKGROUND OF THE INVENTION

Maintenance of a clean eating area is an important objective for fast food restaurants and food court management. It is desirable to encourage patrons to deposit their own trash in a refuse receptacle when finished eating. Patrons do not like to use refuse receptacles that are overflowing, and they often wish to dispose of their refuse in a touchless manner. It is particularly desirable to encourage children to develop the habit of depositing their refuse in a receptacle rather than to leave it lying on a table.

One way to encourage use of waste receptacles by patrons is to ensure that the receptacles are emptied in a timely manner, before they are jammed to overflowing. This involves a number of considerations. First, the amount of trash that can be transported away by staff members is limited. Typically, a refuse receptacle should be emptied when the amount of refuse in the receptacle is around 25-35 lbs. In some locations the weight of material to be manipulated by employees is restricted by regulation. Waste from fast food restaurants is often a relatively low density mixture, primarily of paper and cartons that may fill the receptacle well before the weight limit is reached. In that situation the receptacle will need to be emptied more often than should be necessary, with the additional requirement for the attention of staff that might better be employed in other tasks. In addition, since charges for refuse collection are often related to volume, it is not advantageous to ship low density trash. Consequently, in some instances it is advantageous at least partially to compact the refuse, so that it need not be emptied out as often, and so that it may tend not to have excessive volume for shipping.

In a typical fast food outlet, or food court, some patrons are highly diligent in the disposal of refuse. Other patrons may not be willing to engage in a particularly vigorous search for a waste receptacle, and may only be willing to make a few steps out of their way to deposit trash. Consequently, the fast food restaurant or food court will tend to require several waste receptacles, spread out strategically. For example, it is desirable to have waste receptacles near each door or exit of the eating area, and placed throughout the eating area according to the number of tables and chairs, and the distance to the nearest receptacle.

While it is desirable to have waste receptacles placed to cope with most, or all, contingencies, some locations may tend to be more heavily used than others. One approach to receptacle emptying is to have staff proceed on a regular rotation from receptacle to receptacle on a fixed schedule, and to empty all receptacles in order. The time period between rounds will then be determined by the average time in which the busiest receptacle is filled, less a margin to allow for filling at some times to be faster than at others. Such an approach may tend to have staff checking, and emptying, the majority of receptacles more often than necessary, and yet may still not be often enough for the busiest receptacles at peak times. Another approach is to wait until it is visibly apparent that the receptacles are full, and only to empty them at that time. This may often lead to an unsightly mess, and the extra effort required to clean up an overflow. In addition, when the bin is overfilled it may exceed the allowable weight. Alternatively, through experience an operator may develop a better schedule for checking and emptying receptacles, but will still tend to base collection schedules on estimates of average or peak filling rates that may not yield an optimal use of effort. Even then, such a system depends on employees adhering diligently to the schedule without being distracted. It would be preferable to use a system that notifies an operator that one receptacle or another is approaching a full condition, such that effort can be directed to dealing with actual full receptacles in a timely manner.

In high use locations, it may be advantageous to employ waste receptacles that incorporate a compaction device. In relatively low use locations the additional cost of a compaction unit may not be as readily justified. Consequently an operator may wish to employ a variety, or array, of receptacles some (or perhaps all) having compaction units, and others (or perhaps all) that do not. The choice of compacting or non-compacting units, or a mix of both, will tend to vary according to the circumstances of the specific location.

An interactive receptacle may tend to present a number of advantages. When a proximity sensor is employed, the door of the refuse bin can be opened for the patron, so that the patron need not necessarily touch the refuse receptacle. Many patrons are put off by the thought of touching other people's garbage, or the garbage can itself, and the ability to deposit trash in a touchless manner may tend to be more hygienically appealing. Further, it may be advantageous for the receptacle to be able to interact audibly with the patron. For example, a proximity sensor used to operate an audible, or visible, signal may alert a patron to the location of the waste receptacle, thereby encouraging its use. A verbal message given either by tape or digitally synthesized voice may be attractive to children, and can include a post-deposit message thanking the patron for depositing the refuse in the bin. Children may tend to find obtaining a response from the machine a pleasurable experience. It may be advantageous to employ a program that chooses from a number of verbal responses selected according to feedback from internal weight or volume sensors. Programmable messages, and message synthesis may tend to provide flexibility according to the location, time of day, mix of clientele, and local language, or languages.

While the receptacle can be interactive with patrons, it can also be interactive with restaurant or food court personnel. Not only can a visual signal be provided on the receptacle unit itself to indicate, such as with an amber light “nearly full” of a red light “full”, but, in addition a radio or infra red signal can be transmitted to a central monitoring station, or, alternatively, to a mobile monitoring handset, or communicated to a cellular phone or other portable device carried by a staff member, to indicate the status of each unit in an array of receptacles. When provided with such a signal, much of the guess-work of monitoring the fullness of various units may tend to be reduced, or largely eliminated, with a corresponding potential improvement in efficiency and savings in cost and effort.

It sometimes occurs that receptacles are provided in sets of two or three, whether active (that is, having a compaction unit) or passive (that is, having a receptacle without a compaction unit). In terms of interactive units, a single processor may tend to be able to monitor a larger number of inputs than required for a single unit. In those circumstances it is advantageous to operate more than one receptacle with a single processor, with corresponding savings in cost and weight.

It has been observed that a number of patrons have pinched their fingers at the point at which the top of the refuse door meets the lintel of the refuse door on closing. It is desirable to make it more difficult for fingers to be pinched in this way. The use of a continuous hinge that does not close to a pinch may be advantageous in achieving this result.

It has also been observed that a proximity sensor with a relatively small, more or less conic sensing zone may not necessarily always sense patrons as quickly as might be desired, particularly if they approach from a relatively oblique direction. That is, a narrowly focused sensor may tend to open the refuse access door only when a patron is standing directly in front of the receptacle. Patrons do not, typically, wish to wait for a slow machine to respond, and may tend not to be stoically patient toward, or tolerant of, a lethargic response. It would be advantageous to employ a sensor with a relatively wide angled view to encourage opening of the refuse deposit door earlier.

When an electronic control unit is employed, either for interacting with patrons, for monitoring receptacle status, or for operating a compaction unit, it would be advantageous to be able to service the electronic control unit without undue effort. To that end, it would be advantageous to be able to service or remove an electronic control module relatively easily. Such servicing is facilitated if access to the modules can be simplified, as when the modules can slide to an exposed position.

### SUMMARY OF THE INVENTION

In an aspect of the invention there is a waste receptacle comprising a housing having a space defined therein in which a quantity of refuse can be accumulated. There is an access door mounted to the housing. The access door is movable to an open position to permit refuse to be introduced into the space. There is an actuator operable to move the access door to the open position. A controller is connected to the actuator. The controller governs operation of the actuator. A sensor is mounted to detect the presence of patrons adjacent to the access door. The controller is operable to monitor the sensor. The controller is operable to cause the door to open when a patron is sensed adjacent to the door. An output signal member is operatively connected to the controller. The output signal member is operable to convey a message to the patron adjacent to the access door.

In an additional feature of that aspect of the invention, the output signal member is a loudspeaker. In another additional feature, the controller is operable to cause the output signal member to emit a message chosen from the set of messages consisting of a digitally synthesized voice message and a taped voice message. In still another additional feature, the controller is programmable, to permit use of customized messages.

In yet another additional feature, the patron sensor includes a first sensing element and a second sensing element. The first sensing element is oriented to cover a first approach envelope. The second sensing element is oriented to cover a second approach envelope. The first approach envelope is at least partially different from the second approach envelope.

In a further additional feature, the proximity sensor has a plurality of illumination elements. The plurality of illumination elements is co-operable to cover all of the first approach envelope. In still a further additional feature, the plurality of illumination elements includes at least a first illumination element oriented to cover at least a first portion of the first approach envelope of the first sensing element, and a second illumination element oriented to cover at least a second portion of the first approach envelope. The first and second illumination elements are co-operable to cover all of the first approach envelope.

In another additional feature, a refuse bin is mounted within the housing. The bin is placed to receive refuse introduced through the access door. In yet another additional feature, the housing includes a servicing door. The servicing door is movable to an open position to permit the bin to be emptied. In still another additional feature, the waste receptacle has a compaction unit mounted within the housing to compress refuse accumulated therein.

In a further additional feature, the waste receptacle is free of compaction units. In still a further additional feature, the housing includes a servicing door by which a refuse bin can be stationed in the space to receive refuse introduced through the access door. In yet a further additional feature, the receptacle includes at least one refuse sensor. The sensor is operable to gauge the quantity of accumulated refuse. The controller is operable to monitor the refuse sensor. In another additional feature, at least one refuse monitoring sensor includes at least one sensor chosen from the set of sensors consisting of a weight sensor and a level sensor operable to gauge refuse accumulated on a volumetric basis.

In still another additional feature, at least one of the refuse monitoring sensors includes at least one weight sensor and at least one level sensor. In yet another additional feature, a compaction unit is operatively connected to the controller. The controller is operable to cause the compaction unit to compress the accumulated refuse in response to a signal from the level sensor. In still yet another additional feature, the controller is in communication with a remote communication apparatus, and the controller and the remote receiving apparatus are co-operable to permit staff to be notified remotely of a full condition of the receptacle. In a further additional feature, the remote communication apparatus includes at least one telephonic communication element.

In another additional feature, at least one telephonic communication element is chosen from the set of telephonic communications elements consisting of a cell phone and a beeper. In yet another additional feature, the receptacle is one member of an array of at least two receptacles in communication with the remote receiving apparatus. In still yet another additional feature, at least one of at least two receptacles includes a refuse compaction unit. In a further additional feature, at least one of at least two waste receptacles is free of refuse compaction units.

In another aspect of the invention, there is a waste receptacle system comprising a housing having a space defined therein in which refuse can be accumulated. An access door is mounted to the housing. The access door is movable to an open position to permit refuse to be introduced into the space. A sensor is mounted to detect the presence of accumulated refuse. The sensor is operable to indicate when the accumulated refuse has reached a full condition. A control system is operable to monitor the sensor. The control system is operable to signal the full condition to a person remote from the housing.

In a further aspect of the invention, there is a waste receptacle array system, comprising at least a first waste receptacle, a second waste receptacle, and a remote communication device located away from the first and second receptacles. The first waste receptacle has a housing having a space defined therein in which refuse can be accumulated. An access door is mounted to the housing. The access door is movable to an open position to permit refuse to be introduced into the space. A sensor is mounted to detect the presence of accumulated refuse. The sensor is operable to indicate when the accumulated refuse has reached a full condition. A control system is operable to monitor the sensor. The control system is operable to signal the full condition to the remote communication device located away from the housing. The second waste receptacle has a housing having a space defined therein in which refuse can be accumulated. An access door is mounted to the housing. The access door is movable to an open position to permit refuse to be introduced into the space. A sensor is mounted to detect the presence of accumulated refuse. The sensor is operable to indicate when the accumulated refuse has reached a full condition. A control system is operable to monitor the sensor. The control system is operable to signal the full condition to the remote communication device.

In an additional feature of that aspect of the invention, the remote communication device is operable to notify staff of a full condition any of the first and the second receptacles. In another additional feature, the remote communication device includes at least one telephonic communication element. In still another additional feature, at least one telephonic communication element is chosen from the set of telephonic communications elements consisting of a cell phone and a beeper.

In yet another additional feature, at least one of the at least two receptacles includes a refuse compaction unit. In still yet another additional feature, at least one of the at least two waste receptacles is free of refuse compaction units.

In another aspect of the invention, there is a waste receptacle comprising a housing having a space defined therein in which a quantity of refuse can be accumulated. An access door is mounted to the housing. The access door is movable to an open position to permit refuse to be introduced into the space. An actuator is operable to move the access door to the open position. A controller is connected to the actuator. The controller governs operation of the actuator. A sensor is mounted to detect the presence of patrons adjacent to the access door. The controller is operable to monitor the sensor. The sensor has a first sensor element and a second sensor element. The first sensor element is positioned to observe a first approach envelope relative to the access door. The second sensor element is positioned to observe a second approach envelope relative to the access door. The first approach envelope and the second approach envelope taken together covers a total approach envelope greater than the first range alone, and greater than the second range alone.

In an additional feature of that aspect of the invention, the proximity sensor has a plurality of illumination elements. The plurality of illumination elements is co-operable to cover all of the first approach envelope. In another additional feature, the plurality of illumination elements includes at least a first illumination element oriented to cover at least a first portion of the first approach envelope of the first sensing element, and a second illumination element is oriented to cover at least a second portion of the first approach envelope. The first and second portions overlap each other.

In a further additional feature, the first sensing element and the second sensing element are mounted on a common base, and are spaced apart from each other on the base. In still another additional feature, the first sensing element and the second sensing element are mounted to a common base. The first sensing element is oriented at a first angle relative to the base. The second element is oriented at a different angle relative to the base.

In yet a further additional feature, the sensor has a base, and a vertical plane of symmetry of the base extends normal to the base away from the waste receptacle. The first approach envelope lies at least predominantly to one side of the plane, and the second approach envelope lies predominantly to the other side of the plane.

In another additional feature, the first and second approach envelopes overlap. In still another additional feature, the sensor includes at least two illumination elements placed to co-operate with the first sensing element. In yet another additional feature, each of the first and second approach envelopes is illuminated, at least in part, by more than one illumination element.

In a further additional feature, the sensor is an infra red proximity sensor. In yet a further additional feature, the sensor includes infra red light emitting diodes and the first and second approach envelopes are illuminated by the light emitting diodes.

In another aspect of the invention, there is a waste receptacle. It has a housing having a space defined therein in which refuse can be accumulated. The housing has a first panel. The first panel has an opening formed therein through which refuse can be introduced into the space. An access door is mounted to the first panel, the access door being movable to an open position to permit refuse to be introduced into the space. The housing and the access door mate along respective straight edges and are joined by a hinge running parallel to the straight edges. The panel has a first inner face and a first outer face. The access door has a second inner face and a second outer face. The hinge has first and second wings mounted to the first and second inner faces of the panel and the door respectively. The hinge has a hinge pin. Each of the first and second wings have tabs bent about the hinge pin. The hinge pin is mounted adjacent to the first and second outer faces of the panel and the access door respectively.

In an additional feature of that aspect of the invention, the tabs are formed on a circular arc to engage the pin. The tabs have an outer radius. The first and second outer surfaces lie in a plane when the access door is closed. The tabs lie tangent to the plane. In a further additional feature, at least one of (a) the panel and (b) the access door, is inwardly relieved, such as by a chamfer, to accommodate pivoting motion of the access door about the hinge to an open position.

In a still further additional feature, at least one of (a) the first wing and (b) the second wing of the hinge has a proximal portion adjacent the hinge pin and a distal portion lying away from the hinge pin. The proximal portion is joined to the distal portion at a bend. In yet another feature, the bend is a dog leg formed to seat the first proximal portion and the distal portion about a chamfer.

In yet another feature, the hinge is a continuous hinge extending along the majority of the length of the respective straight edges. In a still further feature, the hinge pin has a pivot axis and the axis lies closer to the outer face of the panel than to the inner face. In another feature, the closed position of the door the proximal portion of the first wing and the proximal portion of the second wing are oriented at an acute included angle from each other, and as the access door is moved to an open position the included angle diminishes.

In another feature, in the closed position of the access door, the proximal portion of the first wing of the hinge lies in a first plane. The proximal portion of the second wing lies in a second plane. The first and second planes intersect along a line of intersection. The hinge pin has a pivot axis. The line of intersection lies further from the inner face of the first panel than the hinge pin axis. In a still further additional feature, the line of intersection of the first and second planes moves further away from the hinge pin axis as the access door is opened.

### BRIEF DESCRIPTION OF DRAWINGS

FIG. 1 shows a plan view of an eating area served by waste receptacles employing the principles of the present invention;

FIG. 2a is a general arrangement isometric view of an example of a compacting waste receptacle used in the eating area of FIG. 1;

FIG. 2b is a view of the compactor of FIG. 2a with portions of its external panelling removed to expose the internal structure of the compactor in an extended position;

FIG. 2c is a view of the compactor of FIG. 2a with portions of its external panelling removed to expose the internal structure of the compactor in a retracted position;

FIG. 3 is a cross-section of the compactor of FIG. 2a taken at section ‘3-3’, and showing the structure of a door mechanism;

FIG. 4 is a three quarter view of a door panel of the compactor of FIG. 2a;

FIG. 5 is an isometric exploded view of elements of the drive system of the compactor of FIG. 2a;

FIG. 6 is a cross section of some of the drive elements of FIG. 5 as assembled;

FIG. 7 shows an alternate embodiment of the compactor of FIG. 3;

FIG. 8 illustrates a portion of the operating logic of the compactor of FIG. 2a;

FIG. 9 illustrates another portion of the operating logic of the compactor of FIG. 2a;

FIG. 10 illustrates a lower portion of an alternative embodiment of a waste compactor for co-operation with a rolling bin;

FIG. 11a shows an isometric view of a non-compacting two bin waste receptacle used in the eating area of FIG. 1, with service doors closed;

FIG. 11b shows the waste receptacle of FIG. 11a with a servicing door open;

FIG. 11c shows a partial view of the waste receptacle of FIG. 11a with control module exposed in an outward position;

FIG. 11d shows the control module of FIG. 11c in an open position;

FIG. 11e shows a view of the control module of FIG. 11c from underneath;

FIG. 12 shows a cross-sectional view of a refuse receiving door of the waste receptacle of FIG. 11a;

FIG. 13a shows a top view of a cross-section of a patron sensor taken on section ‘13a-13a’ of FIG. 12; and

FIG. 13b shows an electrical schematic of the patron sensor of FIG. 13a.

### DETAILED DESCRIPTION OF THE INVENTION

The description which follows, and the embodiments described therein, are provided by way of illustration of an example of a particular embodiment, or examples of particular embodiments, of the principles of the present invention. These examples are provided for the purposes of explanation, and not of limitation, of those principles and of the invention. In the description which follows, like parts are marked throughout the specification and the drawings with the same respective reference numerals. The drawings are not necessarily to scale and in some instances proportions may have been exaggerated in order more clearly to depict certain features of the invention

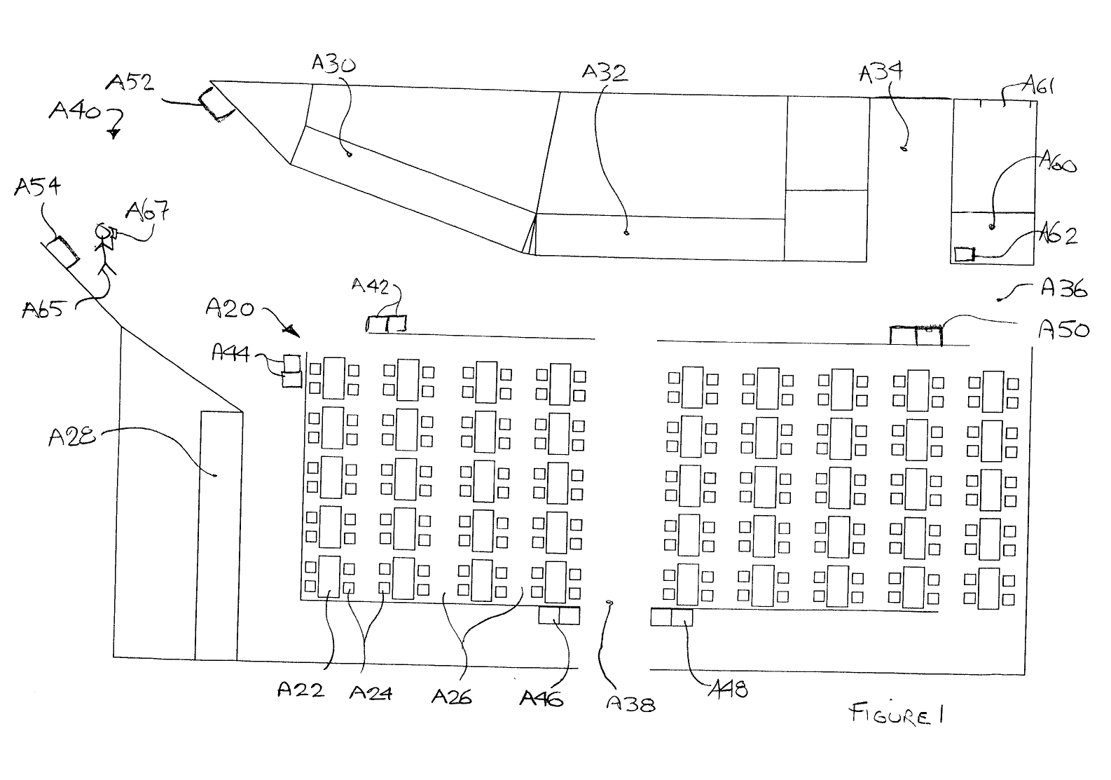

In FIG. 1 an eating area is indicated generally as A20. Eating area A20 could be the seating area of a fast food restaurant, or the shared seating area of a food court. In the embodiment illustrated eating area A20 has a large number of tables A22 and chairs A24 distributed along aisles A26. Retail food counters at which patrons can purchase beverages and food are indicated as A28, A30, and A32. One aisle, or corridor A34 leads to restrooms, and to an exit A36 to an adjacent play area and park (not shown). An aisle A38 leads to doors leading outside to a park or parking lot (not shown). A further corridor A40 leads through an open gallery into an adjacent shopping mall.

High traffic, compacting refuse receptacles A42 and A44 are located at the head of corridor A40 next to the seating area. Medium traffic, passive (that is, noncompacting) double unit receptacles A46 and A48 are placed adjacent to the end of aisle A38 next to the parking lot. Low traffic single unit passive receptacle A50 is placed adjacent to the door to the play area near corridor A34, and a further two single unit passive receptacles A52 and A54 are located some distance along corridor A40 to provide a further opportunity for patrons to dispose of food wrappings before moving into the stores of the adjacent mall. A waste disposal office A60 is located at the end of eating area A20 and has a rear exit A61 at which waste disposal vehicle can be loaded to carry away the collected waste. Waste disposal office A60 also includes a monitoring station A62 at which the status of the various receptacles A42, A44, A46, A48, A50, A52 and A54 are monitored. Each of receptacles A42, A44, A46, A48, A50, A52 and A54 is equipped with a signal transmitter that communicates with a remote communication apparatus including a computer console A64 of monitoring station A62 either along a fixed land line wire, or by radio. A staff member, shown as a stick man A65, has a telephonic communication device in the nature of a cell phone A67 that is operable to receive messages sent by monitoring station A62 to provide notification that one or another of the waste receptacles requires attention. As illustrated, item A67 is representative of not only cell phones, but of other electronic devices such as beepers. Monitoring station A62, and console A64 need not be stationary, but can be portable devices, such as can be carried by a staff member doing rounds or other duties.

Each of the receptacles has a weight sensor and a volume sensor. The weight sensor indicates the weight of material collected in the bin. This weight is compared by the control module with the allowable weight, and a corresponding full or partially full signal is generated accordingly. Similarly, the volumetric sensors in the passive units indicate when the bin is nearly full, or full, in terms of volume of refuse, without regard to weight. Inasmuch as the control module is programmable, it can be provided with local regulatory information, such as allowable weight, to store in memory. The control module can be used to provide not only “full” or “almost full” signals, but also a real time indication of either the actual signalled weight, or the signalled level observed at the weight and volumetric sensors. When one or another of the receptacles provides a nearly full, or full indication, staff can then respond to the signal to empty that specific receptacle, such as by having a display console present a real-time read out in a central office. In the preferred embodiment staff are not required to wait at monitoring station A62, but rather are provided with cell phones, although another type of telephonic device, such as a beeper could be used as an alternative. Console A64 includes a microprocessor that sends a phone message (which can, for example, be by wireless telephony or by land line as may be convenient) to the staff member when one or other receptacle requires attention. Thus when no receptacle requires emptying, staff may continue to attend to other tasks rather than waiting idly.

Each of the receptacles units of A42, A44, A46, A48, A50, A52 and A54 has a proximity sensor, or sensor assembly A55, mounted to sense the approach of patrons. Proximity sensor assembly A55 has a wide angled scope, or range of coverage feature, described below, so that it may tend to sense patrons approaching from a relatively wide range of directions. When the presence of a patron is sensed by proximity sensor assembly A55, the internal computer of the receptacle causes the refuse inlet door to open. When the door is opened, patrons can deposit refuse in the bin of the receptacle, without having to touch anything other than their own tray. That is, they may tend to be able to make a “touchless” deposit of refuse. The units also each include a speaker. This permits the computer to emit audible signals to passersby, and, in particular, to speak to patrons. When first sensed, the receptacle can provide an encouraging message, such as “I am hungry, please feed me”. When the refuse has been deposited, the receptacle can emit the audible message “Thank You”, or some other suitable phrase. Thus each receptacle is able to operate interactively with either the patrons, or with staff.

As noted above, eating area A20, is served by an array of waste receptacle units that includes both compacting units, such as units A42 or A44, and units that are free of compaction apparatus, such as units A46, A48 and A50. Each of units A42 and A44 is a double unit, made up of two single compaction units, such as unit 20, described in greater detail below. Each of non-compacting units A46 and A48 is a double unit of two non-compacting receptacle assemblies, such as the double unit 350, also described in greater detail below.

For the purpose of avoiding repetition and duplication of description herein, although unit 20 is a single unit, and unit 350 is a double unit, compacting units such as unit 20 can be made in a double unit housing, with the same general format as unit 350, and non-compacting units can be made in a single unit housing, such as the single unit housing of unit 20. Similarly, although unit 20 employs an internal skeleton, or frame, of steel members and external panel members mounted to the steel frame skeleton, compaction units can be made with a housing made of panels forming an exoskeleton, mounted atop a wheeled undercarriage in the manner of housing 364 described below, suitable for the forces experienced during compacting. Conversely, passive units can be made with internal steel frame skeletons, as in unit 20. Similarly, a wheeled bin assembly, namely bin 28, could, be used in a non-compacting waste receptacle, and an un-wheeled bin could be used in a compacting receptacle, subject to the ability to align the bin relative to the compacting unit, and to providing a load path for reaction of the compaction forces. Similarly too, a slide-mounted control unit, or a wide angled proximity sensor, or an interactive voice signal apparatus as used in unit 350 could be placed in unit 20, and a single control unit can be employed to operate a pair of compaction units sharing a common housing. That is, in general, and with due regard to the forces and functions of the various elements, a feature shown in the context of unit 350 can be taken as being suitable for use in the context of unit 20, and a feature shown in the context of unit 20 can be taken as being suitable for use in the context of unit 350, without further need for specific description of each possible combination and permutation of these features.

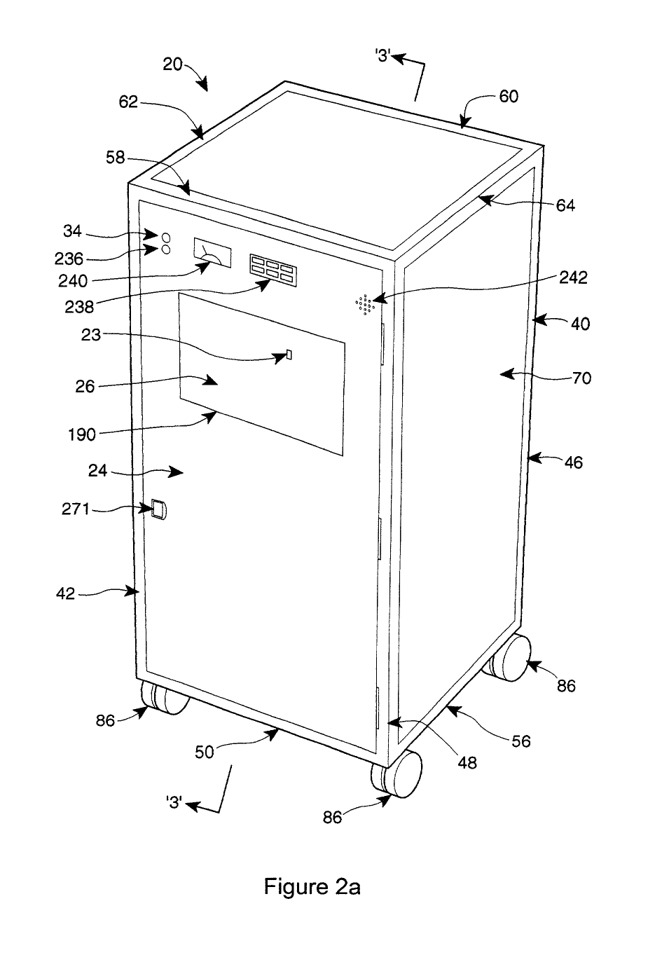

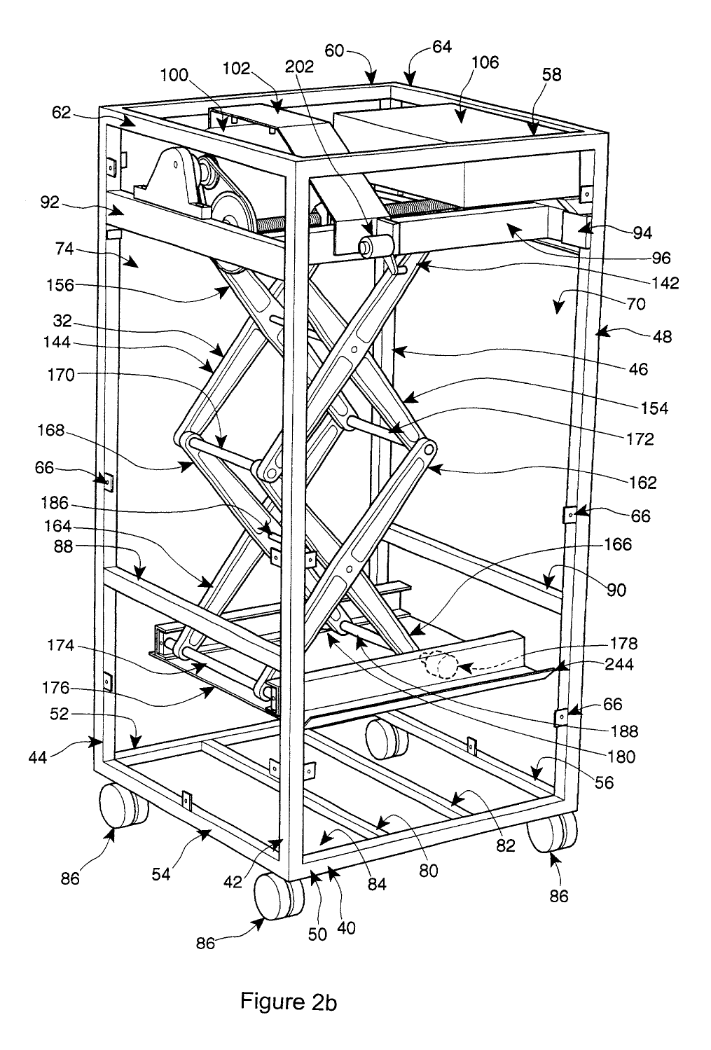

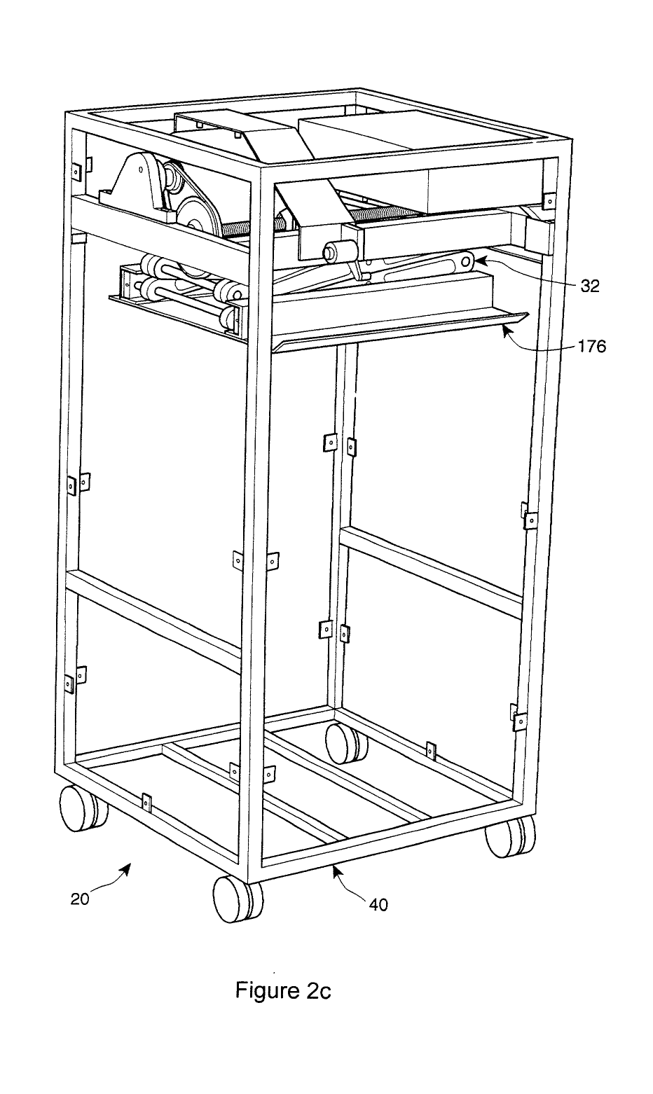

By way of a general conceptual overview of a single compacting unit, such as used in pairs in the double units A42 and A44, in operation, a person carrying a tray of garbage approaches a garbage compactor unit 20 such as is shown in FIG. 2a. A proximity sensor identified as door sensor 22 is mounted to peer through an aperture 23 in the front panel 24 of unit 20 to sense the approach of a patron adjacent to panel 24. When a person approaches unit 20 with a tray, a refuse receiving access door, indicated as inlet door 26, opens. Garbage introduced at door 26 falls inside unit 20 to collect in a receptacle in the nature of a garbage bin 28 that has a liner, or bag 29 for collecting refuse. After a number of such deposits the loose pile of garbage in bin 28 will be sufficiently high to activate a sensor mounted to detect the presence of accumulated refuse, identified as pile sensor 30. A compression unit in the nature of a scissors jack mechanism 32 is then extended to compress the garbage. Once the compression is complete, mechanism 32 retracts and awaits the next full signal from pile sensor 30 before compressing the garbage again. When the unit reaches a full condition, an annunciator, or signalling device in the nature of a signal light 34, signals for an operator to open front panel 24, which is hinged to form a door, to remove the collected garbage. In addition, or as a preferable alternative, an electronic control unit conveys a message to remote monitoring station A62 to inform the operator of the full condition.

Referring to FIGS. 2a, 2b,and 2c, the structural skeleton of unit 20 is a support structure in the nature of a frame 40 that has four hollow square steel tube corner uprights 42, 44, 46, and 48 whose bottom ends are joined by lower front, rear and side peripheral tube members 50, 52, 54, and 56, and whose top ends are joined by upper front, rear and side peripheral tube members 58, 60, 62 and 64. Frame 40 has mounting tabs, 66 to permit the mounting of the outer casing made up of left and right hand side panels 68 and 70, front panel 72, rear panel 74, and top panel 76. When assembled, unit 20 forms an enclosure, or housing, that has a space, or accommodation, in which a receptacle for accumulating refuse, such as bin 28, can be received. When unit 20 is in operation, ribs 80 and 82 carry the reaction force on bin 28 to the other members of frame 40. This load path forms a closed loop since the other end of the compression unit is also mounted, ultimately, to frame 40 as will be described below. Thus the force of compression is contained within unit 20, and is not passed to the ground. Frame 40 has a pair of intermediate cross bars, in the nature of ribs 80 and 82, extending between lower front and rear peripheral tube members 50 and 52 to support bin 28, and to carry, on their lower face, a bottom closure panel 84. Frame 40 itself rests on rollers 86 mounted at each corner, although it could rest on non-rolling feet. A pair of sidewall cross supports 88 and 90 extend between uprights 42, 44 and 46, 48 respectively.

Mechanism 32 is also mounted to frame 40. A pair of relatively deep main left and right hand fore-and-aft stringers 92 and 94 are mounted to uprights 42, 44 and 46, 48 at a level corresponding generally to the upper extremity of inlet door 26. A pair of generally parallel front and rear main cross braces 96 and 98 span the distance between stringers 92 and 94, inset asymmetrically from uprights 42 through 48, such that a centerline drawn between, and parallel to braces 96 and 98 is closer to the back of unit 20 than to the front. A main motor 100 is mounted to a motor mount 102 that extends like a bridge between braces 96 and 98. A motor belt tensioning strut is indicated as 104 and extends between brace 96 and motor 100. Also mounted across braces 96 and 98 is a controller enclosure 106 that houses the programmable logic circuitry (that is, the electronic controller) that governs operation of unit 20. Enclosure 106 is removable as a module for repair, maintenance and upgrade as required. The electronic controller can be programmed on site to permit customized aural messages to be registered in memory (or on tape) for later emission to patrons or servicing personnel.

It is preferred that the controller housed within enclosure 106 be in communication such as by wireless radio transmission with a remote monitoring apparatus, such as monitoring station A62, whether the monitoring station is in a fixed location or is a portable unit carried by staff.

Referring to FIGS. 2b, 3 and 5, motor 100 is slung from mount 102 and supported by braces 96 and 98 as noted above, in a position to be concealed behind front panel 72 and below top panel 76. It is located within the enclosure envelope of unit 20 in the location least likely to accumulate splattered material. Motor 100 is a 1/2 h.p. reversible, 4 pole single phase induction electric motor with a nominal speed of 1725 r.p.m. It turns a small pulley 110 which is linked by a timing belt 112 to a driven sheave 114. The speed reduction in this step has a ratio of 1:3. Sheave 114 is mounted to turn a jack screw 116. Jack screw 116 is a ¾″ acme screw having 6 threads per inch. It is carried in bearings 118 at either end mounted in stringers 92 and 94.

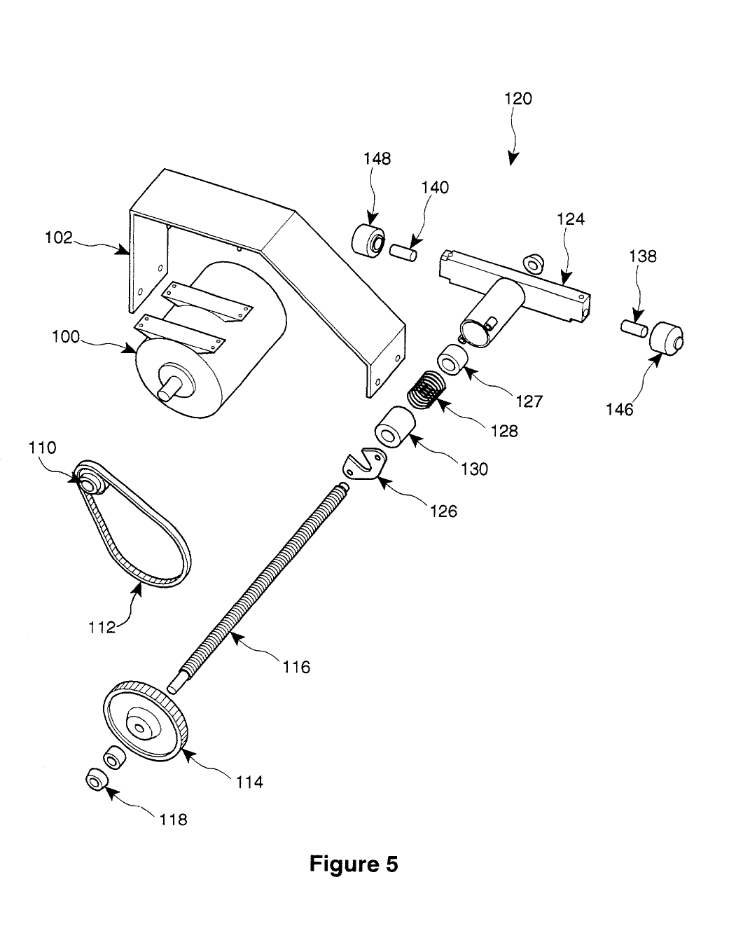

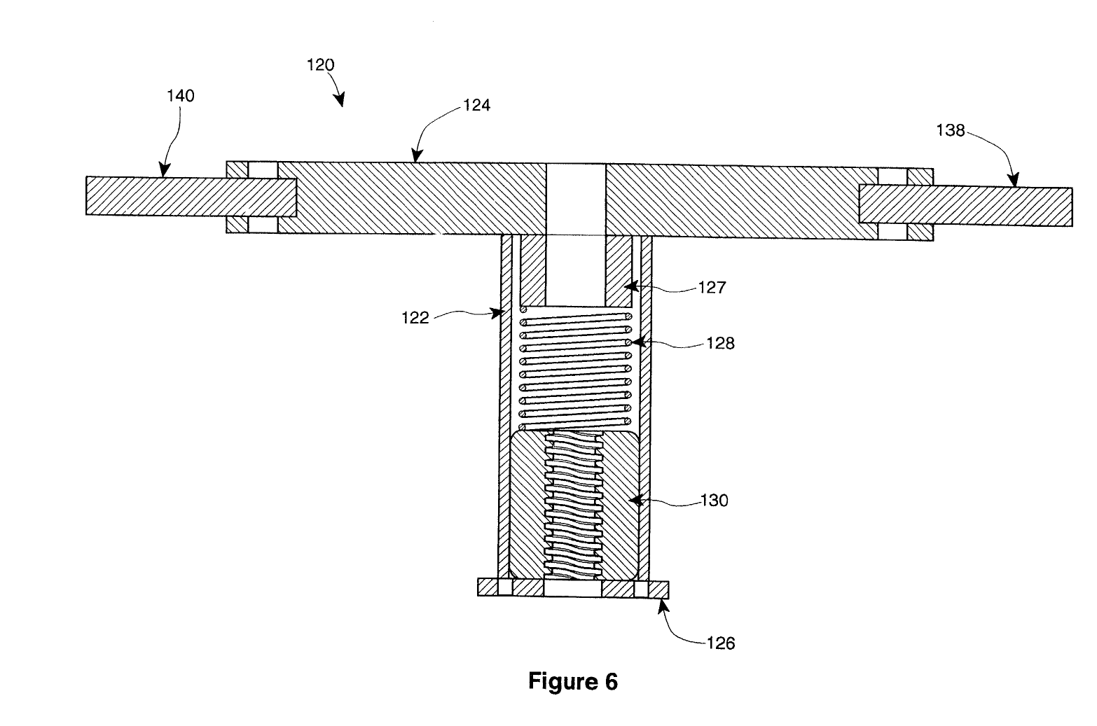

Mounted in threaded engagement with jack screw 116 is a crosshead yoke assembly 120, shown in the exploded detail of FIG. 5 and in the cross-section of FIG. 6. It has a socket formed by mounting a sleeve 122 perpendicularly to a transverse yoke beam 124. A capture plate 126 is attachable at the bolt bosses of sleeve 122 to capture a spacer, 127, a resilient cushioning member in the nature of a spring 128, and a screw follower, or screw engaging member in the nature of a Delrin (T.M.) nut 130. As assembled, nut 130 functions as a screw follower, and the remainder of assembly 120 acts as a drag member for governing the motion of whatever is attached to the ends of yoke beam 124. Spring 128 is located to transmit motion, in at least one direction, between the screw follower, nut 130, and the drag member.

When the drive system is returning to is initial, retracted position, the notched portions of beam 124, activates a microswitch 134 mounted to brace 98 to cause the unit to stop. In the time delay while this occurs and motor 100 decelerates, nut 130 will continue to travel, but will slow down as it compresses spring 128. The presence of spring 128 causes the stop to occur more smoothly, and over a longer period of time, than might otherwise be the case. It discourages the jerking motion sometimes seen with this kind of equipment. A through bore through all of assembly 120 accommodates screw 116. In an alternative embodiment, springs can be placed to either side of Delrin (T.M.) nut 130 to cushion motion in both directions.

Transverse yoke beam 124 has, mounted at either end thereof, stub shafting 138 and 140 at either end, upon which a pair of primary translating arms in the nature of front and rear first scissor arm links 142 and 144 are mounted in bushings. At the outer extremities of yoke beam 128 are a pair of front and rear upper cam followers in the nature of rollers 146 and 148, that ride along respecting front and rear upper cam tracks 150 and 152. Cross braces 96 and 98 are channel shaped sections with mutually inwardly facing toes such that the profile of the channel itself yields tracks 150 and 152.

A pair of front and rear primary pivoting arms 154 and 156 are mounted to pivot at one end on bushings mounted at fixed pivot points spaced apart on a common pivot axis shaft 158 perpendicular to jack screw 116 and cam tracks 150 and 152 such that the linear path of the centers of rollers 146 and 148 lies on a radius extending perpendicularly away from the axis of shaft 158. Pivoting arms 154 and 156 are linked to scissor arm links 142 and 144 by a primary fulcrum pivot shaft 160 located midway between the respective ends of links 142, 144, and arms 154 and 156. In the preferred embodiment fulcrum shaft 160 is located at the mid-point of each of the respective arms, but this is not a necessary condition for the operation of such scissors devices in general.

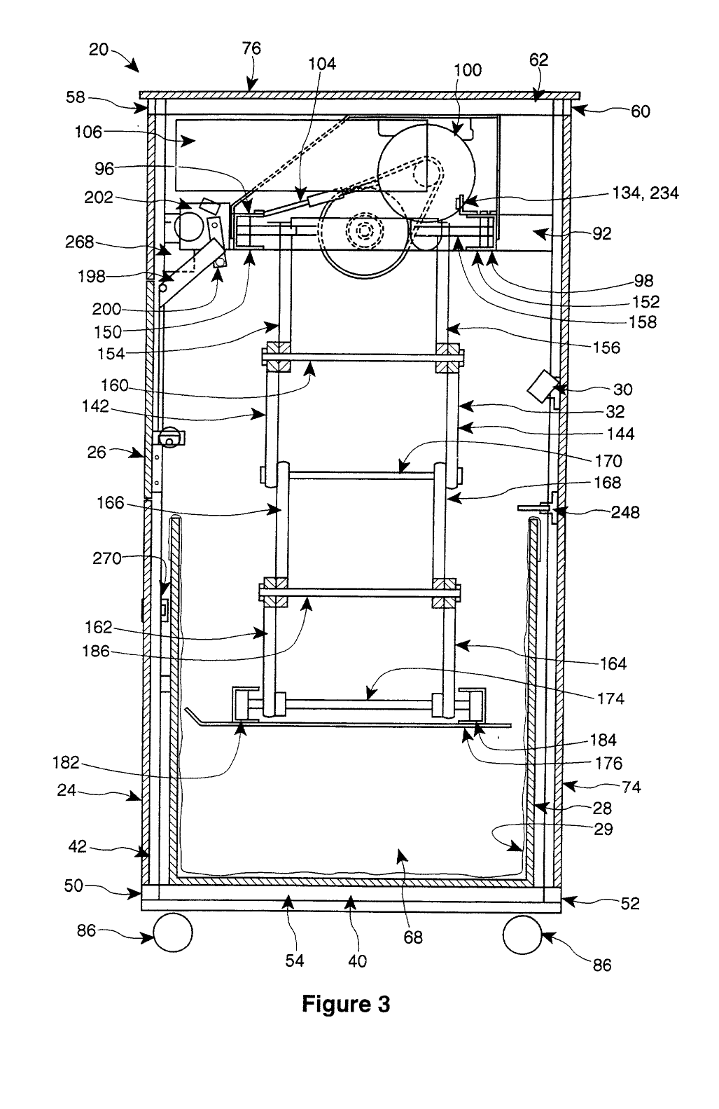

Connected in folding-accordion fashion to the distal ends of arms 154 and 156 and links 142 and 144, are respective front and rear secondary pivoting arms 162 and 164, and secondary translating links 166 and 168. These pairs of arms are also cross linked at their respective end joints by intermediate pivot shafts 170 and 172. As shown in FIG. 3 arms 162 and 164 are stepped outward from arms 154 and 156 to lie generally in the same respective vertical planes as links 142 and 144. Similarly, links 166 and 168 are stepped inwardly of links 142 and 144 to lie in the same respective vertical planes as arms 154 and 156. At their most extreme points, arms 162 and 164 are pivotally mounted in fixed location bushings on a common shaft 174 mounted to the upper side of a compression member in the nature of a pressure plate 176. Links 166 and 168 have outwardly extending stub shafts and rollers 178 and 180 that are engaged in slides, in the nature of trackways 182 and 184 formed from channels mounted to the upper face of pressure plate 176. Rollers 178 and 180 share a common shaft 188. As above, secondary arms 162 and 164 and secondary links 166 and 168 cross in scissors like fashion. They are linked on a common fulcrum axis by secondary fulcrum shaft 186.

As illustrated, shafts 138, 140, 158, 160, 170, 172, 174, 186 and 188 are all intended to be parallel. Shafts 138, 140, 172 and 188 are coplanar. Shafts 158, 170 and 174 are coplanar. Shafts 160 and 186 are coplanar. The linear paths traced by the center of rollers 178 and 180 lie on radii extending perpendicular to the axis of shaft 174. From this geometry, the paths of trackways 150, 152, 182 and 184 are all mutually parallel, and perpendicular to the axes of the various shafts. For this geometry the direction of extension and retraction of pressure plate will be in a direction parallel to the bisector of the angle at fulcrum shaft 160 defined between the legs of line 142 (or 144) and arm 154 (or 156) that have feet constrained, respectively to pivot about shaft 158 and to follow the linear path of trackways 150 and 152.

Also, in the case of the geometry illustrated, this bisector will lie in the plane of the axes of shaft 160 and 186. The pivot axes 158 and 174, respectively fixed in location relative to the support structure of braces 96 and 98, and to pressure plate 176, always lie to one side of this plane. The axes of rollers 146, 148, 178 and 180 which are constrained to follow the linear paths of their respective trackways, always lie to the other side of the bisector plane. Furthermore, as shown, the bisector plane is perpendicular to the linear travel of the rollers in the trackways. While the geometry of linkages of this type can be varied, the inventors have found it convenient for the fulcrums to be located at the mid point of the members (that is items 142, 144, 154, 156, 162, 164, 166 and 168), and for the members to be of equal lengths.

Given the mechanical relationship of motor 100, jackscrew 116 and scissor mechanism 32 generally as described above, forward operation of motor 100 to drive sheave 114 will tend to draw crosshead yoke assembly 120 toward the axis of shaft 158, extending scissor mechanism 32. The vertical force exerted by plate 176 for a given torque in jackscrew 116 will tend to increase as the arms and links extend. As pressure plate 176 encounters more resistance in compressing garbage, at whatever height, motor 100 will tend to draw a greater current and produce a greater torque until the chosen current limit is reached. This load can be measured directly, with load cells or other devices, or it can be measured indirectly by measuring motor current to give suitable feedback.

Whether the scissors mechanism is a single scissors mechanism having a single fulcrum axis, a double scissors mechanism having two fulcrum axes as illustrated, or a multiple scissors mechanism having a larger number of fulcrum axes, scissor mechanisms have, in general, an input end having a pair of legs extending from a common fulcrum axis, and an output pair of members, arms, or fingers, extending from a fulcrum axis. In the case of a single scissors mechanism, the fulcrum axis will be the same in both instances. The legs at the input end will have feet, or toes, that are alternately drawn together to extend the mechanism, and driven apart to retract it. At the output, there are feet mounted to a device to be extended.

In the preferred embodiment the input feet are the ends of input arms 154 and 156 that are constrained to pivot about the axis of shaft 158, and the ends of links 142 and 144 that are constrained to follow the linear path traced by rollers 146 and 148 along trackways 150 and 152. The output feet are the ends of the secondary pivoting arms 162 and 164, constrained to pivot about the axis of shaft 174, and the ends of secondary translating links 166 and 169 that are constrained to follow the linear path of rollers 178 and 180 in trackways 182 and 184.

It would be possible to use only one scissors mechanism, but lateral stiffness is improved by mounting two such systems in spaced apart parallel relationship, as shown in the preferred embodiment. That is, the front mechanism, which includes arm 156, is parallel to the rearward mechanism, which includes arm 158. It would also be possible to use a different kind of compression unit, whether a mechanism that depends on gears, hydraulics, of a vertical screw driving a plate. Unit 20 is intended to provide a moderate amount of compaction to relatively loose, mostly paper garbage of the kind found, for example, in malls and at fast food restaurants and the like. The electrically driven scissors mechanism of FIG. 3 is preferred, since it permits unit 20 to be free of a hydraulic system and hydraulic fluid.

The fixed axes of shafts 158 and 174 may tend to reduce the tendency of plate 176 to twist as compression occurs, as compared to a scissors mechanism in which both sides are permitted to travel. A reduction in twisting is desirable, since it reduces the probability that plate 176 will ride against, and damage, the inner walls of bin 28. Such twisting can further be discouraged by the use of gears and torque tubes, as noted below since this will tend to compel the legs, that is the translating links, to advance in their trackways at the same rate.

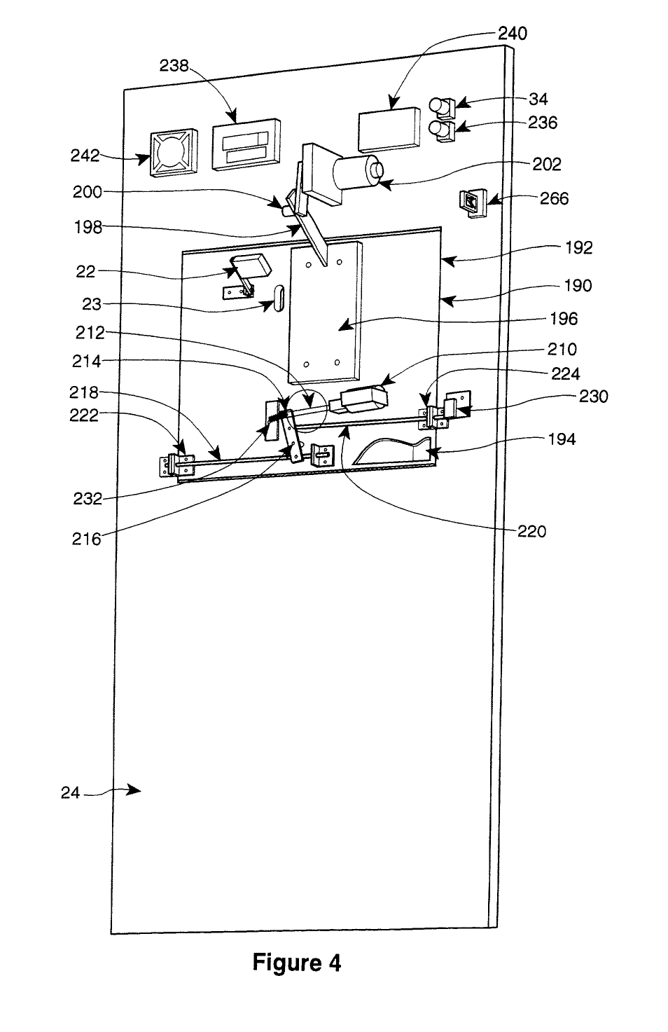

Operation of mechanism 32 occurs after garbage has been deposited through inlet door 26 of front panel 72. FIG. 4 shows the inner face of front panel 72. A generally rectangular opening 190 is defined in the upper region of panel 72, and a door 26, of a size to mate with opening 190 pivots inwardly and upwardly of panel 72 about a hinge 192 extending along the upper margin of door 26 and opening 190. A scrap section of a door covering 194 is shown. For the purposes of explanatory illustration cover 194 has been removed except for the partial section indicated. In actual use covering 194 covers all of the working parts mounted to door 26, as described below, to discourage the accumulation of sticky materials on them.

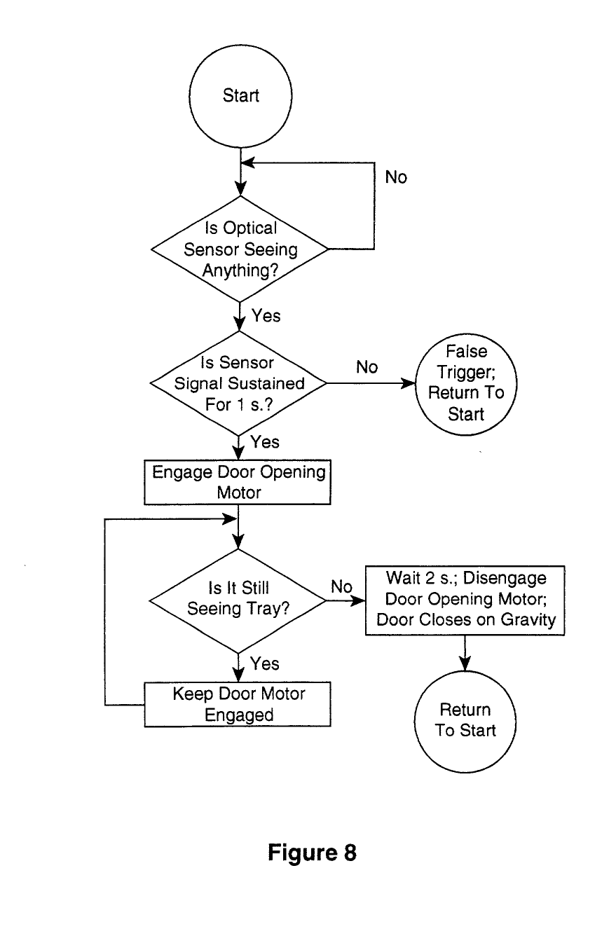

Located on the upper portion of door 26 is a cam follower made of a bracket 196 fastened to door 26 by rivets, screws or other means. Bracket 196 has an inwardly and upwardly extending arm 198. An actuator arm 200 is mounted to frame 40 and is driven by a door motor and driving linkage 202 provided that the compression member is in its retracted, or inactive position, when door sensor 22 senses that a person is approaching to dump garbage, actuator arm 200 is driven forward to engage inwardly extending arm 198. Although actuator arm 200 and door motor and linkage 202 are mounted to motor mount 102 in front of brace 96, they are shown in FIG. 4 to illustrate the spatial relationship to arm 198. As the motion continues, inwardly extending arm 198 rides against actuator arm 200 as a cam follower follows a cam, until door 26 reaches its fully open position. Door 26 is held in the fully open position as long as sensor 22 is activated. When sensor 22 is deactivated, and after a time delay of 2.0 seconds, actuator arm 200 is returned to its initial, inactive position. Notably, door 26 is not driven closed to lessen the probability of catching a person's fingers. If a person's fingers are still in the door, then only the weight of the door will bear against them. The logic of this process is set out in the flow chart of FIG. 8.

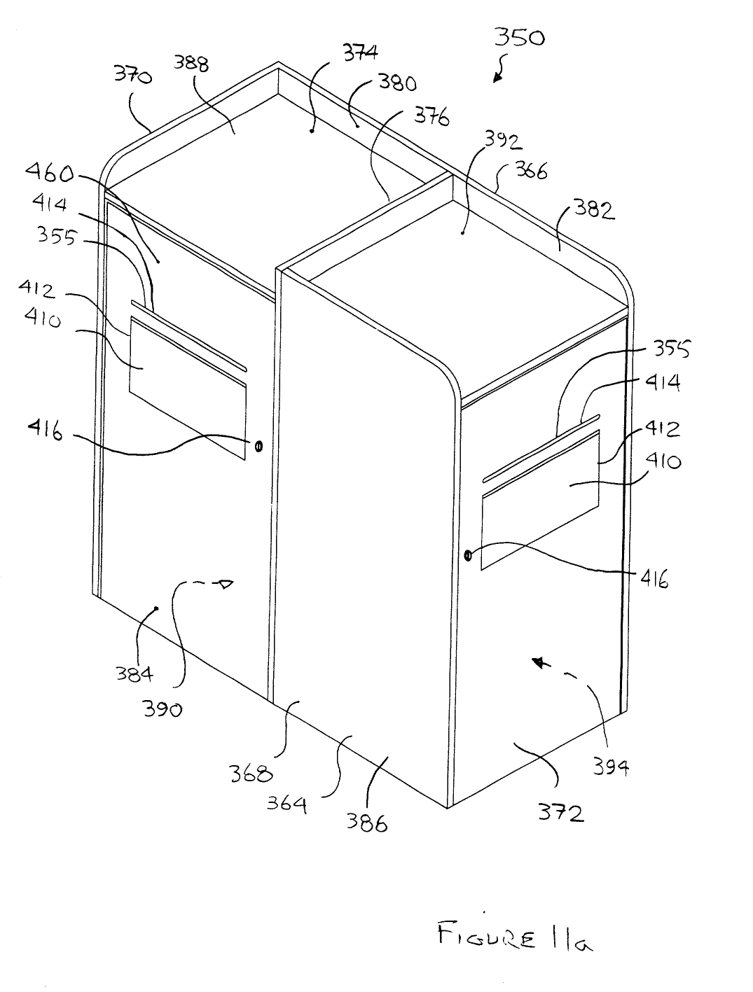

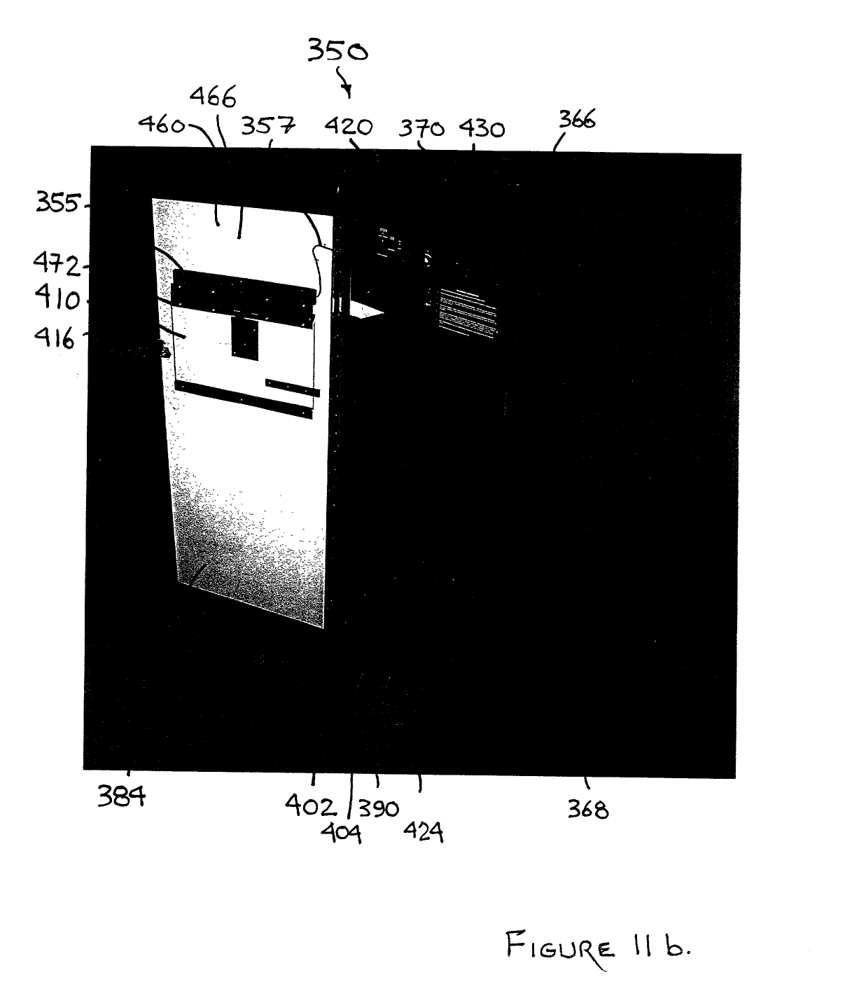

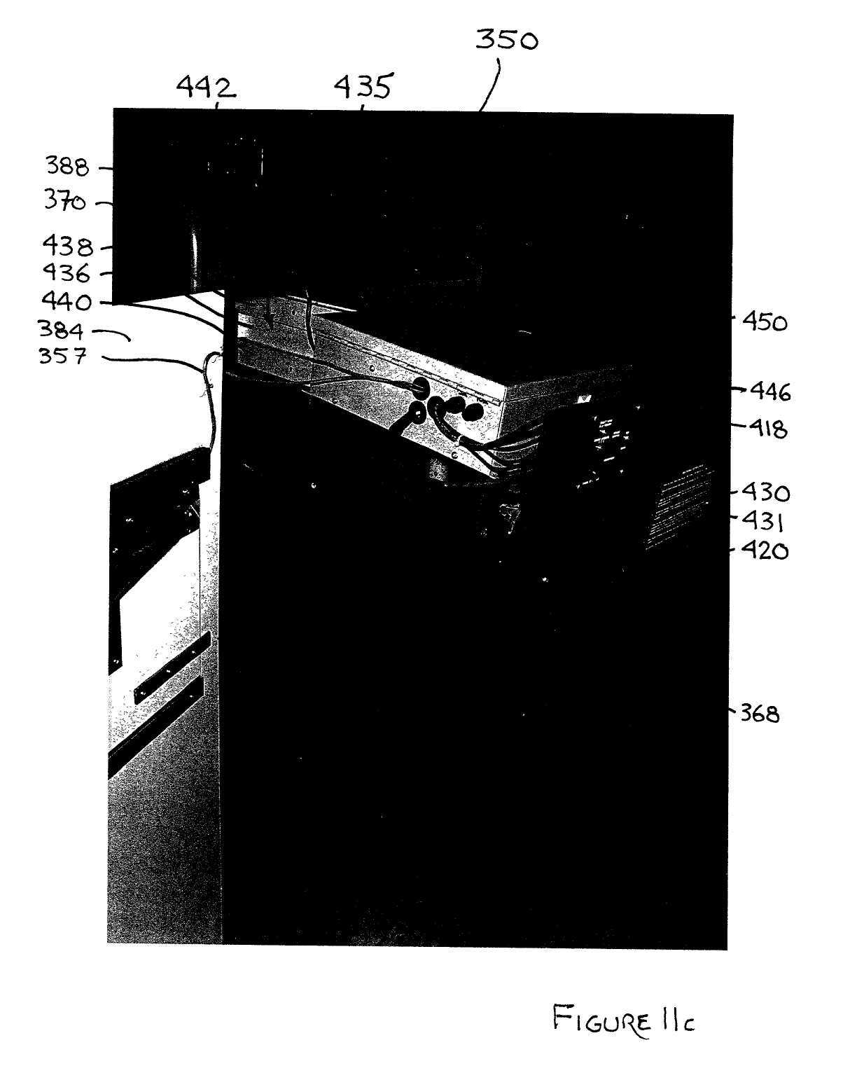

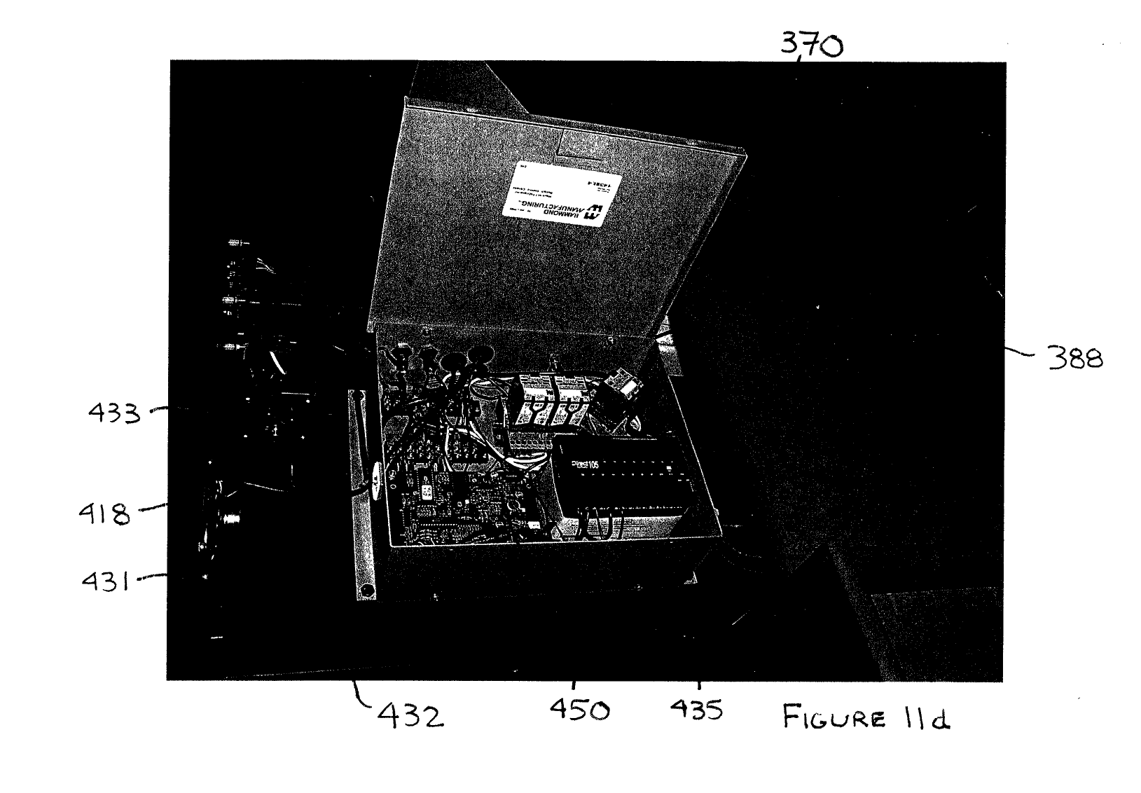

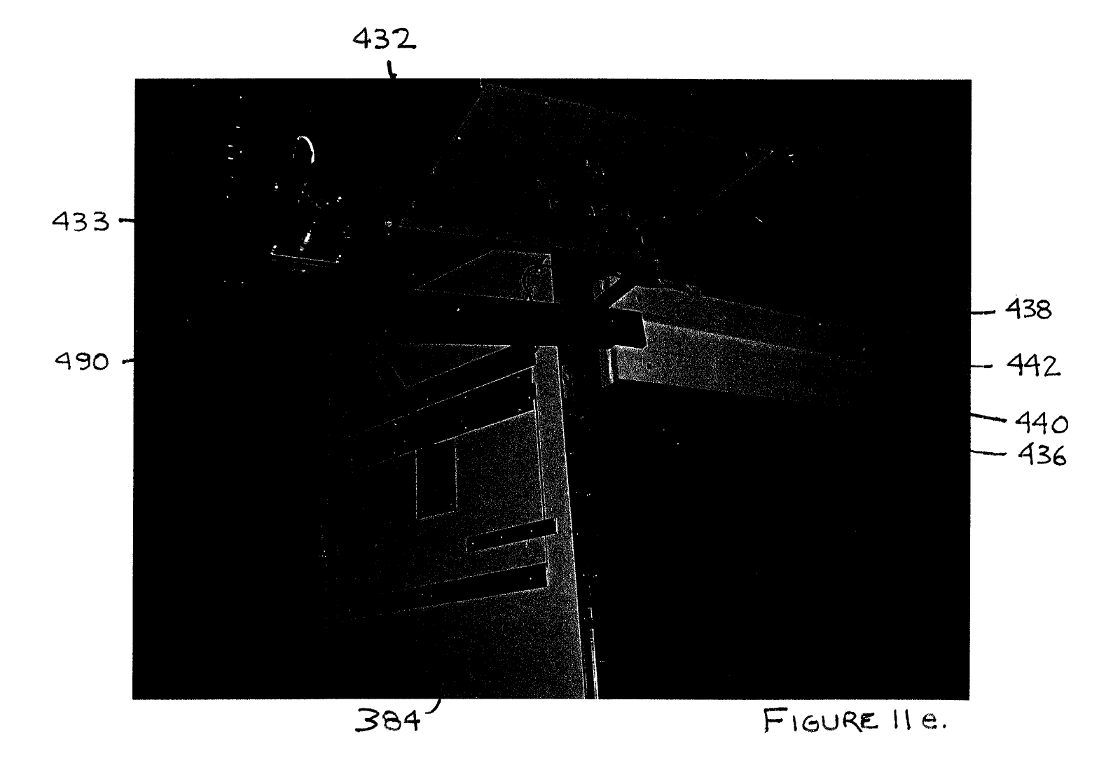

An alternate, preferred access door actuator mounting arrangement is shown in FIGS. 11d and 11e. In that arrangement the door actuator is mounted to the face plate of the electronic control unit frame, and is in a fixed position relative to the control unit. When the servicing door is closed inwardly extending arm 158 is located in a position for engagement by the actuator arm.

On the lower inside portion of door 26 there is a solenoid 210 arranged to extend or retract a connecting rod 212. Connecting rod 212 bears upon a crank 214 mounted to pivot about a fulcrum 216. A pair of links 218 and 220 each have one end mounted to crank 214, one between fulcrum 216 and rod 212, and the other being to the other side of fulcrum 216. The distal ends of links 218 and 220 are restrained by a slide 222 or 224 respectively. Slides 222 and 224 are located to place the distal ends of links 218 and 220 opposite to a pair of door lock sockets 226 and 228 mounted on the inside face of panel 26. In the general case, when pile sensor 30 has not received a high garbage signal, solenoid 210 is inactive. Its coil is not energized, and so its body is relatively cool. When it is activated, rod 212 is forced outward to turn crank 214 about fulcrum 216, in turn driving links 218 and 220 outward through slides 222 and 224, and into locking engagement in sockets 226 and 228. Notably, unlike a known type of garbage compactor in which a solenoid is used to engage a locking socket, neither slides 222 and 224 nor sockets 226 and 228 is hot, so the tendency for sticky liquids to dry and become encrusted is reduced. Solenoid 210 does become warm when cycled “On”, but is less exposed.

As noted above, scissors mechanism 32 will not be activated until door 26 is locked closed. To achieve this, a full travel microswitch 230 is mounted to panel 36 and is activated when the locking mechanism is driven fully home. Rod 212 has a return spring 232 to urge links 218 and 220 toward their disengaged position when solenoid 210 is deactivated. An alternate, preferable access door locking system employs a solenoid mounted to the inside face of the door jamb to engage a socket in the moving access door.

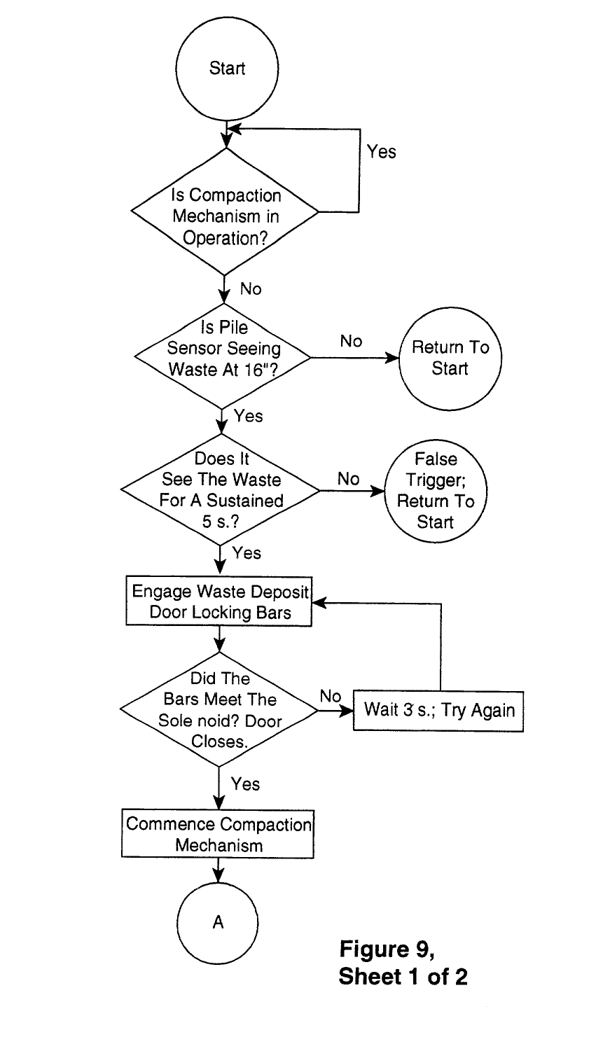

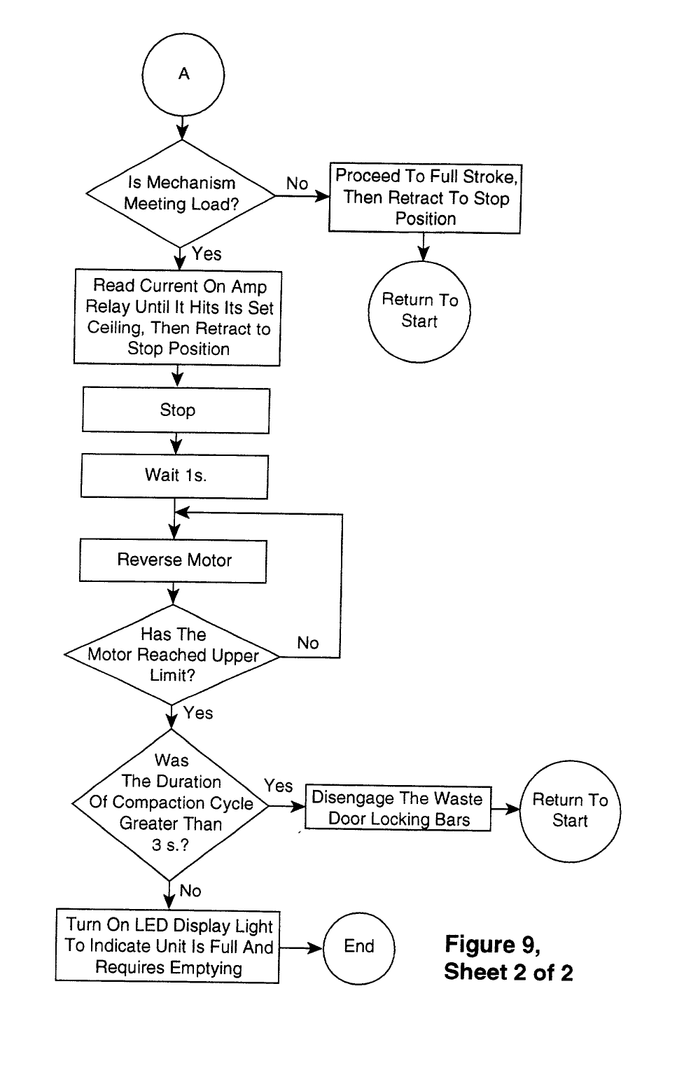

Also as noted above, unit 20 includes a level, or proximity, sensor indicated as pile sensor 30 for sensing the height of the pile of garbage in bin 28. Pile sensor 30 is mounted to frame 40 at an angle to rear panel 38 of unit 20. It is aimed to sense pile height closer to the rear of bin 28 than to the front, on the general assumption that the trajectory of the garbage entering through door 26 will generally result in a pile that is deeper toward the back than toward the front. Pile sensor 30 is a background suppressed sensor. It is looking for a pile height that is nominally 16 inches, as indicted in FIG. 9. However, it will be understood that loose garbage is unlikely to collect in a level manner at a precise height. Rather, there will be a random variation of height within bin 28. The pile sensor does not rely on brightness of reflection, since that may vary according to the reflectivity of the particular object. Instead, sensor 30 has a pair of beams that cross at a focus, such that the device detects whether any object is present, rather than how bright the reflection may be. Pile sensor 30 provides a means for gauging the level of refuse in the receptacle in an approximate manner.

As reflected in the logic of FIG. 9, when an object is detected by pile sensor 30, the system tests to make sure that the signal persists for a significant period of time, at least 5 seconds in the preferred embodiment, to allow the garbage to settle somewhat. If the sensor still senses the presence of garbage after 5 seconds then a signal is sent to lock door 26 in the closed position. Once it is confirmed that door 26 is locked then the compression unit is activated in response to the signal from pile sensor 30. Motor 100 begins to drive jack screw 116 to extend mechanism 32, carrying pressure plate 176 downward as it does so.

The time of operation of motor 100, and its current draw are monitored. The extension (and retraction) can occur in any of three regimes. First, if motor 100 operates for less than 3 seconds, and yet the current draw is 120% of the design rated current draw, then the controller infers that bin 28 is full. Jack screw 116 is turned in the other direction, and the “receptacle full” signal light 34 is activated to tell staff to empty bin 28.

The second regime is a load limited regime. If the motor current then increases to exceed the preset value, then the controller infers that plate 176 has encountered material, and has compacted it enough to reach the desired density. In that case the extension stroke ends, plate 176 is retracted to its initial, or inactive stored position, and unit 20 goes into a waiting mode until sensor 30 again senses material. The use of a load limit in this way may tend to encourage longer motor life.

In the third regime, if motor 100 current does not reach the limiting value, then a full travel microswitch 234, mounted to brace 98, will be activated by the notched end of yoke beam 124 when plate 176 reaches full stroke displacement limit. Microswitches 134 and 234 are mounted in line, roughly 8 inches apart, on brace 98. In the preferred embodiment the full stroke displacement limit corresponds to 90% of full stroke length that would occur if the mechanism were allowed to advance until the scissor arms jammed. The microswitch can be set to be tripped by plate 176, or by some part of mechanism 32 or by counting the number of turns of motor 100, or any other suitable means. It is preferred to measure the travel of the sleeve on the jack screw, since this part of the mechanism is less likely to accumulate splattered material. In the event that microswitch 234 is tripped, the logical inference is that bin 28 is almost empty. Plate 176 is then retracted to its rest position above the level of door 26.

When the full condition is reached, signal light 34 on the front console of the unit is illuminated, to notify the operator to empty bin 28. In addition, a message is transmitted by the electronic controller to monitoring station A62. The control module is capable of sending real time date of the sensed by the weight and level sensors to monitoring station A62 to permit staff to observe the actual values for the various receptacles. The controller module is also operable to generate messages to servicing personnel and patrons when the either (a) the receptacle is full, in which case a message such as “This waste receptacle is presently full, please use another” can be conveyed; or (b) the compactor is in operation, in which case a message such as “The compactor will be finished operation soon, please wait” can be conveyed. In an optional embodiment the motor controller can count the elapsed time to end of stroke on a current based limit. When it is less than, for example, 3 seconds, a light 236 of one colour, such as yellow, can be illuminated to warn the operator that bin 28 is almost full, and a red light, such as signal light 34 can be illuminated when the “receptacle full” condition is reached. A number of other output signal members, or devices, could be used alternatively or additionally for indicating the amount of garbage collected in the receptacle, or for conveying messages to patrons or staff. Either an LED display 238 showing the percentage of fullness or a direct weight measurement, or a gauge 240 with a pointer on a scale, or similar mechanical or electrical system, or a speaking synthesized voice system, or taped message system, including a loudspeaker 242, could be used.

It should be noted that the programmable controller polls the status of door sensor 22 and pile sensor 30 continuously. If one of these becomes active, then operation of the other part of the system is inhibited. That is, if the compactor is operating, door 26 will not be opened, whatever sensor 22 may indicate. Similarly, if door 26 is being held open in response to a signal from sensor 22, the compaction unit will be disabled while door 26 is open. If the controller senses input signals that are contradictory, then it inhibits both door 26 and scissors mechanism 32 from working, and displays and transmits a fault warning instead. This fault warning can be a flashing light signal, as from light 34, or a fault code display on LED display 238, or by use of some similar audio or visual warning means as well as a radio message sent to monitoring station A62. If one of the sensors becomes inoperative, as for example, if pile sensor 30 were to be covered with ketchup, then a warning signal is displayed and transmitted accordingly.

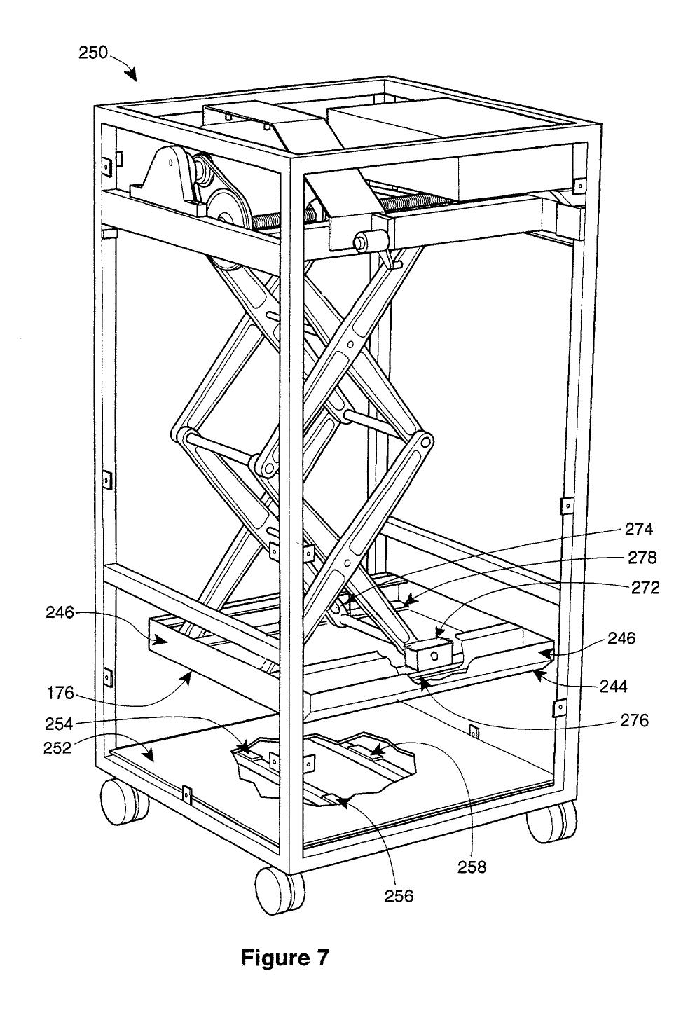

Pressure plate 176 has an upwardly bent lip 244 along its front edge. In an alternative embodiment as illustrated in FIG. 7, the entire periphery of pressure plate 176 has an upwardly extending lip or skirt 246 to discourage material from accumulating on top of plate 176. In addition, an inwardly oriented flexible wiper 248 (shown in FIG. 3) is mounted to the inside faces of front panel 72, rear panel 74, left hand side panel 68 and right hand side panel 70 at a level roughly corresponding to the top of inlet door 26, close to the upper limit of the retraction stroke of pressure plate 176. As plate 176 rises wiper 248 is intended to encourage cups, napkins and other material that may have become caught on the edges of plate 176 to be stripped off. Wiper 248 can have bristles, or be made of a rubber strip, or have a plurality of inwardly oriented flexible fingers that deflect as plate 176 passes.

As noted above, the fullness of bin 28 can be inferred by a direct weight measurement. This provides a second means to increase the tendency to stay within the local weight limit. Furthermore, it permits the weight in bin 28 to be recorded by the programmable logic controller as a function of time. In normal use the weight in bin 28 will increase relatively slowly. A sudden increase in weight could indicate that matter has been dumped in bin 28 that may not be suitable for compression. As illustrated in the optional alternative embodiment of compactor 250 of FIG. 7, the support for bin 28 is provided by a floor panel 252 shown in scrap section to reveal three load cells 254, 256, and 258 upon which floor panel 252 rests. Load cells 254, 256, and 258 are in turn mounted in a three point triangular array to ribs 260 and 262 that complete the load path to frame 264 generally. (The remainder of frame 264 is, unless noted otherwise, the same as frame 40). The increase in the sum of the values sensed at load cells 254, 256, and 258 over the empty weight of bin 28 will yield the weight of refuse in bin 28. More than three load cells could be used if desired. Although other, mechanical weigh scale systems could also be used, load cells are capable of withstanding the loads imposed during compression of the refuse in bin 28, (in the range of 600 to 1000 Lbs.) and yet provide sufficiently accurate discrimination of smaller weights in the 0 to 50 Lbs. range. The signals from the load cells and their variation with time are monitored and the result displayed on display 238. In the event of a sudden increase in weight, such as a jump in excess of 3 Lbs., display 238 can be used to provide a fault warning to the operator at monitoring station A62, and to prevent further operation of the compression unit until the contents of bin 28 have been examined.

Whether activated inferentially as in the first regime described above, or directly by a weight measurement, when the “receptacle full” signal is given, it is intended that an operator will empty out the collected garbage and return an empty receptacle for the next load. Front panel 24 has mounted to it a contact in the nature of an electrically conductive key 266 that fits in a mating socket 268 mounted to doorjamb 270. If an electrical connection is not made through key 266 and lock 268, power cannot reach motor 100. It is intended that it not be possible to operate motor 100 when front panel 24 is open. When an operator unlocks and opens door handle 271, door panel 24 swings outward, withdrawing key 266 from socket 268, and breaking the main power circuit to motor 100.

It is possible to achieve this in a number of alternative ways. For example a logic system could be used to sense the position of the door, and, through software or relays, prevent the motor from being activated. Alternatively microswitches could be mounted either at the hinge or at the closure of door 24. The engaging electrified lock is preferred because, unlike some microswitches, it is relatively difficult, if not impossible, to fool or tape closed. Further, it is not vulnerable to a software failure. With the power shut off to motor 100 , a person is able to reach inside and remove bin 28, to remove the full bag 29 and to replace it with a new bag. Although door panel 24 is shown with hinges along the righthand side, the arrangement of the hinges, handle 271, key 266 and socket 268 could be reversed to permit door panel 24 to swing to the other side.

In the alternative, preferred, embodiment illustrated in FIG. 7, rollers 168 and 170 can be replaced by slider blocks 272 joined by a shaft or torque tube 276, and trackways 172 and 174 can be replaced by mating slides 278.

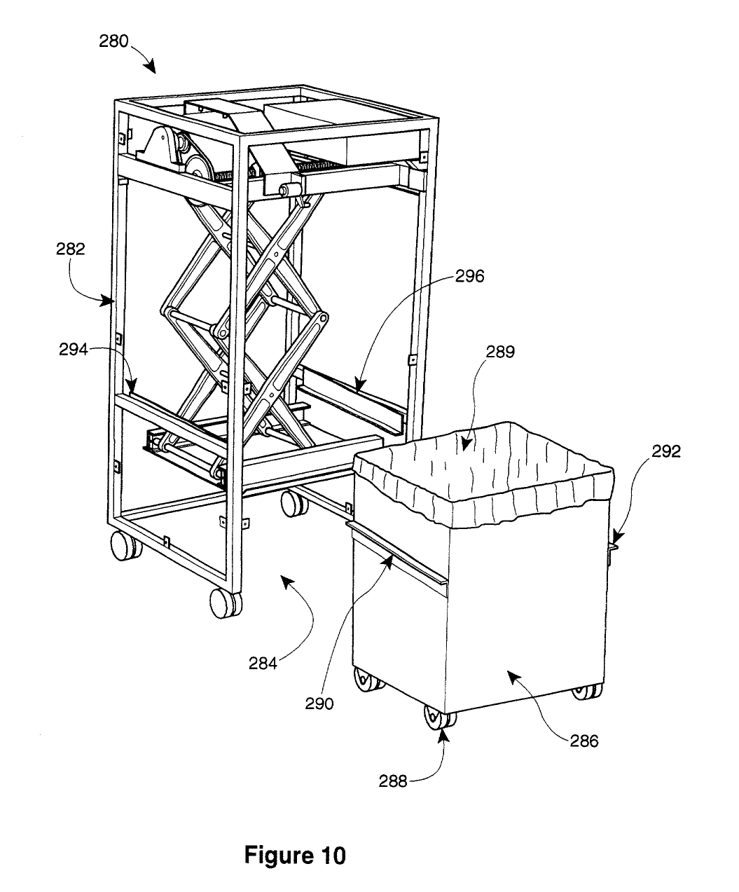

In another alternative embodiment of the invention, as shown in FIG. 10, a compactor unit 280 has a frame 282 that differs from frame 40 of the preferred embodiment of FIG. 2, in that front lower peripheral member 50 has been removed, leaving a U-shaped entranceway 284. This permits use of a bin 286 mounted on wheels 288 as shown, so that a person emptying unit 280 can roll the existing load away, and replace bin 286 with an empty bin. Bin 286 can then be rolled to the nearest dumpster, bag 289 can be removed, and a new bag put in place.

Bin 286 is equipped with frame engagement members in the nature of inclined side flanges 290 and 292. These engage, and ride upon, receptacle engaging members in the nature of inclined flanges 294 and 296 that have an angle of incline of 3 to 4 degrees. For the last few inches of travel, the entire weight of bin 286 is lifted off wheels 288, and carried by flanges 294 and 296 instead. Flanges 294 and 296 can be mounted directly to cross supports 88 and 90, or can be mounted to load cells mounted on supports 88 and 90, to permit the weight of garbage to be monitored over time. In use, the force during the compaction cycle holds bin 286 firmly in place on flanges 294 and 296. The location of bin 286 in suitable position is further assured by the position of front panel 24, which, when closed, limits the movement of bin 286. Other engagement means could be used, including detent catches, wheels chocks, latches, and other similar mechanical devices.

It is not necessary that the access panel for removing full bins be the front panel of the unit. Either the side or back faces could be used. However, it is preferred that the front face be used as this permits several units to be lined up side by side or back to back. Equally, although the preferred scissors jack mechanism, 32, is shown as a double scissors jack (that is, is has an upper, or primary scissor pair which transmits motion to a lower, or secondary scissor pair), it could be made in a single scissor, or a multi-scissor unit, depending on the space available and the stroke to be achieved. It is, or course, not necessary that a scissors jack be used. A geared system or a compacting screw, or a hydraulic system could be used. However, a mechanical linkage system, such as scissors jack 32 is preferred.

For the purpose of description, a description of non-compacting double unit of passive receptacle 350 will serve to describe unit A46, and, other than being of opposite hand, also unit A48. Although units A46 and A48 have doors in one side face and one end face, units can be made with two doors on the same side, doors on opposite sides in a kitty-comer manner, or doors on both ends, according to the need of the eating area operator.

Passive receptacle 350 is shown in FIGS. 11a, 11b, 11c, 11d and 11e. Passive receptacle 350 has an enclosure assembly in the nature of a structural shell, or housing, 364, designed to accommodate a “two unit” set of receptacles. That is, housing 364 has walls, or panels, defining back side 366, a front side 368, a first end wall 370, a second end wall 372, a top 374, and, an internal divider in the nature of a medial partition wall 376 standing in a plane parallel to end walls 370 and 372. The various walls or panels co-operate to form a generally rectilinear box enclosure.

Back side 366 is a rigid planar sheet. First end wall 370 is a rigid planar panel that extends at right angles from one of the vertically extending edges, or margins, of back side 366. Partition wall 376 extends from the middle of back side 366 toward front side 368, such that a first portion 380 lies to one side of partition wall 376, and a second portion 382 lies to the other. Front side 368 includes a first, door panel, portion 384 in the nature of a servicing door hinged to the front vertically extending edge, or margin of, first end wall 370 lying parallel to portion 380 of back side 366, and a second, rigid portion 386 lying parallel to second portion 382 of back side 366. Second end wall 372 is a hinged wall, or door, hinged to the otherwise free vertically extending edge, or margin, of portion 386 of front panel 368.

Top 374 includes a first portion 388 bounded at its margins by portion 380, of back side 366, partition 376, end wall 370, and door panel 384, such that those panels cooperate to define a first enclosed space 390 for housing a control module, described below, and a refuse receptacle, or bin, such as to bin 28 identified above. Top 374 also includes a second portion 392 bounded at its margins by portion 382 of back side 366, partition wall 376, second portion 386 of front side 368, and the second door panel, namely second end wall 372 such that those panels cooperate to define a second chamber, or enclosed space 394 for receiving a second refuse receptacle, or bin 28, as described above.

The portions of top panel 374 are each set downward slightly, roughly 3 inches, from the upper margins of the vertical wall panels such that three-sided shelves are defined upon which patrons can stack empty food trays.

Housing 364 is mounted on a rectangular steel frame, 400. Steel frame 400 has casters 402 at the comers to permit rolling location of unit 350, and interstitial stringers 404 that are located to support refuse bins within enclosed space 390 or 394. Door panels 384 and 372 are pivotally movable about their hinges between respective closed positions and open positions. When in the open positions refuse bin 28 can be withdrawn and replaced, or withdrawn, the garbage bag liner 29 closed and the garbage bag removed, a new garbage bag liner 29 put in place, and bin 28 replaced in position ready again for filling.

Each of the door portions is of the same construction, and includes an inset refuse access door 410 through which refuse may be introduced into the enclosed space 390 (or 394) defined within housing 364. Access door 410 is mounted in a mating refuse door opening 412. Elements of proximity sensor 355 are mounted in a round-ended rectangular strip 414 seated in a through-slot formed in the door panel (be it 372 or 384) above, and generally parallel to, the upper margin of opening 412. A lock 416 can be moved to a closed position to secure the door (be it 372 or 384) in place.

When door panel 384 is open, staff have access to bin 28 and to the control module carrier unit, 430. Bin 28 is the same as described above and shown in FIG. 3. Bin 28 seats removably on stringers 404, and more particularly, on load cells 424 mounted to stringers 404 so that the weight of trash in bin 28 can be monitored on a continuous basis. An internal proximity sensor is located on the back wall of the enclosure space to sense the volumetric fullness of bin 28 as described above in the context of sensor 30 of unit 20. Control mounted carrier unit 430 includes a frame 432 mounted between a pair of slides, 436. Each of slides 436 includes and upper rectangular slide block 438 and a lower rectangular slide block 440 mounted to the inside wall of end wall 370, or the opposed, facing wall of partition wall 376. Upper and lower slide blocks 438 and 440 are mounted in parallel, and define a horizontally extending rebate, channel, or guideway, 442 along which side frame members 444 of frame 432 can slidingly move. A face plate 446 is mounted to the outwardly facing end of frame 432.

A control module 450 is mounted to frame 432, and contains the control circuitry used to monitor the weight of bin 28 in either enclosed space, to monitor the volumetric fullness of bin 28 in either enclosed space, to monitor the respective wide angled patron sensors, to control operation of the door actuator motor, to control the emission of audio messages, and to transmit signals to the central control station. Only one control module is required for a double unit, the input and output peripheral devices of the second enclosure being connected by means of a cable harness 435 passed through an aperture formed in the upper regions of partition wall 376.

A power “On” indicator light 420 is also provided. An optional written word signboard message display can be provided. Control module carrier unit 430 includes a face plate 431 mounted across the outer end of frame 432. A door actuator 433 is mounted to the front cross member of frame 432 for engagement with the lever arm 490 of refuse receiving access door. An output signal member in the nature of a speaker 418 is mounted to plate 431 and is connected to the electronic control unit, as noted below. A programmable input panel is indicated as 437 and permits custom messages to be input into the control module noted below. Use of a programmable control unit permits audio messages, such as customized messages not only suited to the specific local market in terms of age, or time of day, but also in languages other than English. These voice messages, whether taped, or preferably digitally synthesized, are emitted either to patrons or to servicing staff.

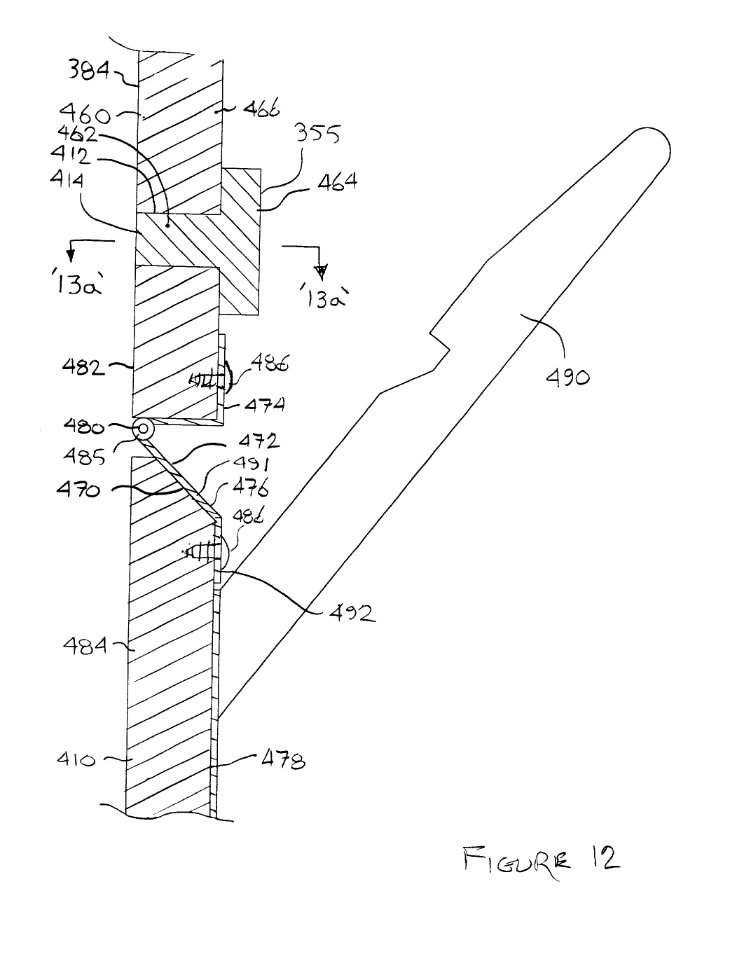

A detail of the door panel, be it panel 384 or 372, is shown in FIG. 12. The upper region of the door panel, that is to say, the region located above refuse receiving access door 410, is indicated generally as 460. The through slot for the wide-angle patron sensor is indicated as 412, as above. The patron sensor 355 is generally T-shaped in cross-section. Sensor 355 has a portion 462 of narrow section engaging slot 412 and a portion 464 of wider section having shoulders that abut inside face 466 of upper region 460 of the door panel. Refuse access door 410 has a chamfered upper edge, indicated as 470, the chamfer being located on the upper inner horizontally extending margin. A hinge 472 has first wing 474 attached to the inner face 466 of region 460, and a second wing 476 attached to the inside face 478 of refuse receiving door 410.

Although hinge 472 is mounted to the respective inside faces 466 and 478 of region 460 and refuse receiving door 410, the axis of rotation of hinge 472, being the central axis of hinge pin 480, is located toward the plane of the outer face 482 of region 460. Subject to tolerance for fit up, it is intended that the outer face 484 of refuse receiving door 410 be co-planar with face 482 when refuse receiving door 410 is in the closed position as indicated in FIG. 12. In this position, the pivot axis of hinge pin 480 lies inward from the plane of the outer surface of the door a distance equal to the radius of the pin plus the thickness of the material of the hinge tabs 485 that encircle and engage pin 480. The rounded tabs of hinge 472 are, subject to manufacturing tolerance, tangent to (i.e., flush with) the plane of the outer surface of the door. In achieving this placement of hinge pin 480, the first wing has a right angled dog leg bend to conform to the lower edge of region 460, the first, proximal, portion of the dog leg bend lying in the horizontal plane of the bottom edge of portion 460. The other, distal, portion of the dog leg bend lies along, and is fastened to, the inner face of upper region 460 by threaded fasteners, namely wood screws 486. Similarly, the second wing 476 has an obtuse dog leg bend having a first, proximal portion 491 lying on the 45 degree chamfer of refuse receiving door 410 and a distal portion 492 lying along, and being fastened to the inner face 478 of refuse receiving door 410 also by wood screws 486 as noted above.

Placement of hinge 480 such that its external tabs are near or at the plane of the front face of the door, as opposed to lying on the inside of the door, may tend to reduce, or possibly eliminate the opportunity for fingers to be pinched between the upper edge of the door and the bottom edge of region 460. This feature is further enhanced by employing a continuous hinge across the upper margin of refuse access door 410 rather than a pair of spaced apart smaller hinges on either side. The hinge itself thus forms a barrier to block the small gap that might otherwise remain, and tends to prevent foreign objects from being slipped into the crack. Geometrically, the faces of proximal portions of the wings lie in first and second planes. When access door 410 is closed, the planes meet along a line of intersection lying forward of (that is, to the outside of the front face 482) and parallel to the axis of hinge pin 480. As access door 410 opens, the line of intersection will tend to move further away from the axis of hinge pin 480.

A refuse door lever arm 490 is rigidly mounted to inside face 478 adjacent to hinge 480 and extends upwardly and inwardly into the enclosed space. When door 410 is closed, door actuator, 433, engages arm 490, causing refuse receiving door 410 to open. If manual pressure is applied to refuse receiving door 410, arm 490 will lift off the cam roller of the door actuator, and will return to position when released. Operation of the door actuator is controlled by the control module in response to signals sent along cable harness 357 connecting the control module to wide angled proximity sensor 355.

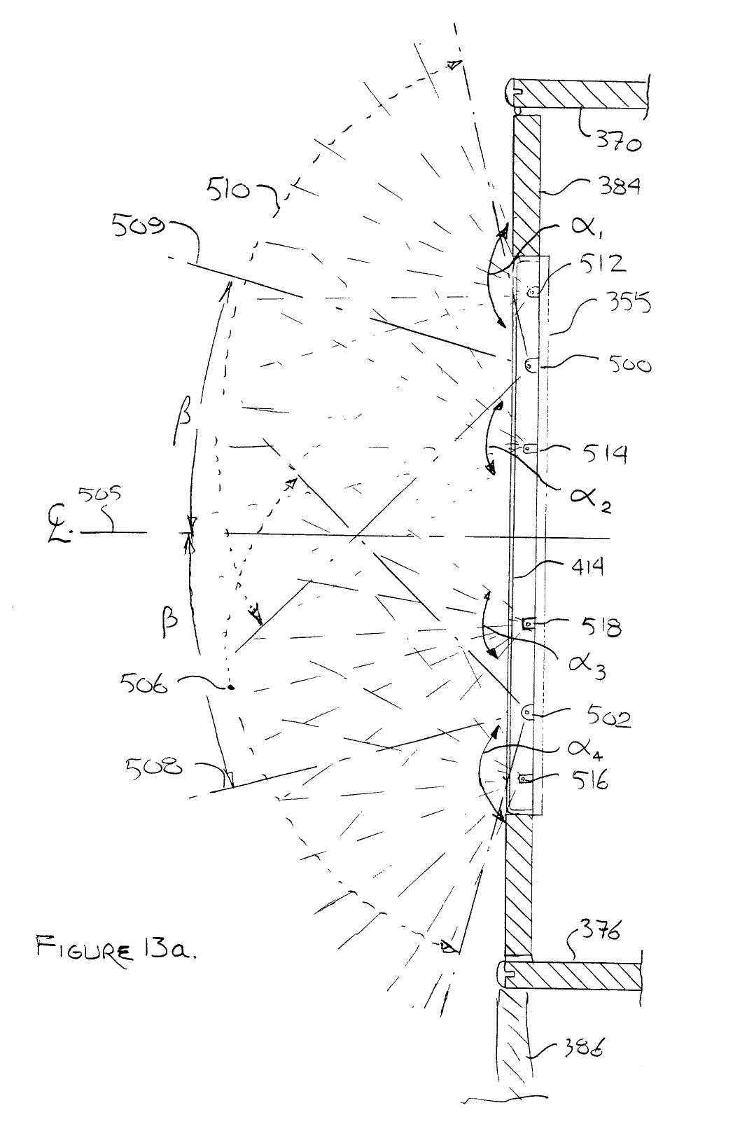

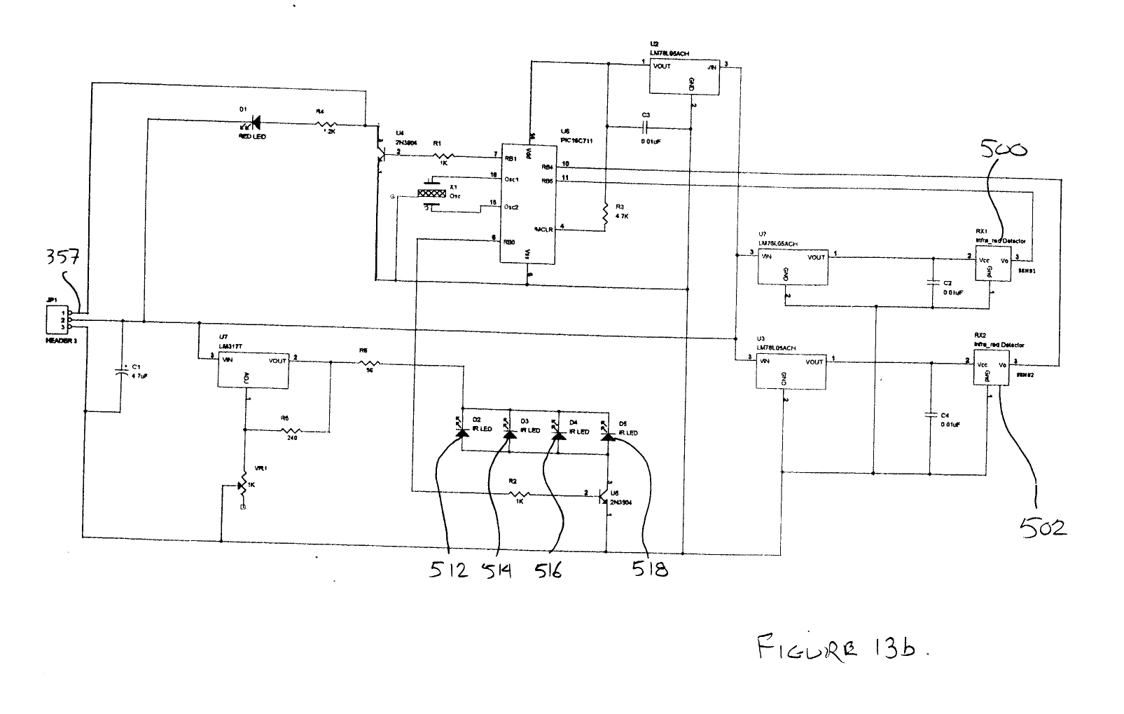

Referring to FIGS. 13a and 13b, proximity sensor 355 includes a first proximity sensing element in the nature of an infra-red detector 500, and a second proximity sensing element in the nature of a second infra-red detector 502. Strip 414 is centrally mounted on door panel 384 or 372, as may be. A vertical central line plane perpendicular to the outer surface of door panel 372, (or 384) is indicated as 505 and bisects strip 414. Infra red detectors 500 and 502 are mounted at either end of strip 414, and, within manufacturing tolerances, are equidistant from plane 505. Infra-red detectors 500 and 502 are also angled away from each other. The range of coverage, or envelope, of detector 502 is indicated as 506, and has a central bisector, or main axis 508 extending (when viewed from above) at an angle β to one side away from vertical plane 505. Similarly detector 500 has a range of coverage, or envelope, indicated as 510, whose main axis 509 lies angle β to the other side of vertical plane 505. As illustrated (not to scale) envelope 506 and envelope 508 have a zone of overlap, such that detectors 500 and 502 co-operate to cover a range of approach envelopes greater than either alone might tend to do. It is preferred that this type of relatively wide angled proximity sensor be employed in unit 20 as well, in preference to the more narrowly focused, single point proximity sensor 22 noted above.

In addition, detectors 500 and 502 pick up a reflected portion of incident beams of radiated illumination from suitable illumination sources. In FIGS. 13a and 13b the illumination sources are infra-red illumination sources. Detector 500 is bracketed by a first illumination element in the nature of a first infra-red LED 512, and a second illumination element in the nature of a second infra-red LED 514. LED's 512 and 514 are spaced apart, angled in a splayed manner, and each have a range of coverage that at least partially overlaps the other. This may tend to provide stronger illumination of objects in the approach region to detectors 500 and 502, and may tend to increase the size of the region in which the illumination is adequate to trigger detection by detectors 500 and 502. In this context, an “illumination source” is a source of radiation in an appropriate frequency for cooperation with the proximity sensing element or elements. An illumination source, in this context, does not necessarily have a wavelength lying in the visible range, but merely a wavelength that matches the desired wavelength, or wavelength range, of the sensor elements, whether visible or otherwise. Similarly, LED's 516 and 518 are arrayed to tend better to illuminate corresponding portions of the zone of approach, or sensing envelope, of detector 502. The use of additional illumination sources in this way may tend to increase, or broaden, the angular extent of the zone of the sensor element, 500 or 502. In the not-to-scale conceptual illustration of FIG. 13a, the zones, or regions covered by the illumination of infra red LEDs 1512, 514, 516, and 518 are indicated as α₁, α₂, α₃, and α₄ respectively.

Various embodiments of the invention have now been described in detail. Changes in, or additions to the above-described examples may be made without departing from the nature, spirit or scope of the invention, the invention is not to be limited to thereby.

What is claimed is:

1. A waste receptacle comprising:
a housing having a space defined therein in which a quantity of refuse can be accumulated;
an access door mounted to said housing, said access door being movable to an open position to permit refuse to be introduced into the space;
an actuator operable to move said access door to said open position;
a controller connected to said actuator, said controller governing operation of said actuator;
a sensor mounted to detect the presence of patrons adjacent to said access door;
said controller being operable to monitor said sensor;
said controller being operable to cause said door to open when a patron is sensed adjacent to said door; and
an output signal member operatively connected to said controller, said output signal member being operable to convey a message to the patron adjacent to said access door.

2. The waste receptacle of claim 1 wherein said output signal member is a loudspeaker.

3. The waste receptacle of claim 1 wherein said controller is operable to cause said output signal member to emit a message chosen from the set of messages consisting of:
(a) a digitally synthesized voice message; and
(b) a taped voice message.

4. The waste receptacle of claim 1 wherein said controller is programmable, to permit use of customized messages.

5. The waste receptacle of claim 1 wherein said patron sensor includes a first sensing element and a second sensing element, said first sensing element being oriented to cover a first approach envelope, said second sensing element being oriented to cover a second approach envelope, said first approach envelope being at least partially different from said second approach envelope.

6. The waste receptacle of claim 5 wherein said proximity sensor has a plurality of illumination elements, said plurality of illumination elements being co-operable to cover all of said first approach envelope.

7. The waste receptacle of claim 6 wherein said plurality of illumination elements includes at least a first illumination element oriented to cover at least a first portion of said first approach envelope of said first sensing element, and a second illumination element oriented to cover at least a second portion of said first approach envelope, said first and second illumination elements being co-operable to cover all of said first approach envelope.

8. The waste receptacle of claim 1 further comprising a refuse bin mounted within said housing, said bin being placed to receive refuse introduced through said access door.

9. The waste receptacle of claim 8 wherein said housing includes a servicing door, said servicing door being movable to an open position to permit said bin to be emptied.

10. The waste receptacle of claim 1 wherein said waste receptacle has a compaction unit mounted within said housing to compress refuse accumulated therein.

11. The waste receptacle of claim 1 wherein said waste receptacle is free of compaction units.

12. The waste receptacle of claim 1, wherein said housing includes a servicing door by which a refuse bin can be stationed in said space to receive refuse introduced through said access door.

13. The waste receptacle of claim 1 wherein said receptacle includes at least one refuse sensor, said sensor being operable to gauge the quantity of accumulated refuse, said controller being operable to monitor said refuse sensor.

14. The waste receptacle of claim 13 wherein said at least one refuse monitoring sensor includes at least one sensor chosen from the set of sensors consisting of (a) a weight sensor; and (b) a level sensor operable to gauge refuse accumulated on a volumetric basis.

15. The waste receptacle of claim 14 wherein said at least one refuse monitoring sensor includes at least one weight sensor and at least one level sensor.

16. The waste receptacle of claim 15 further comprising a compaction unit operatively connected to said controller, said controller being operable to cause said compaction unit to compress the accumulated refuse in response to a signal from said level sensor.

17. The waste receptacle of claim 1 wherein said controller is in communication with a remote communication apparatus, and said controller and said remote communication apparatus are co-operable to permit staff to be notified remotely of a full condition of said receptacle.

18. The waste receptacle of claim 17 wherein said remote communication apparatus includes at least one telephonic communication element.

19. The waste receptacle of claim 18 wherein said at least one telephonic communication element is chosen from the set of telephonic communications elements consisting of (a) a cell phone; and (b) a beeper.

20. The waste receptacle of claim 17 wherein said receptacle is one member of an array of at least two receptacles in communication with said remote receiving apparatus.

21. The waste receptacle of claim 20 wherein at least one of said at least two receptacles includes a refuse compaction unit.

22. The waste receptacle of claim 20 wherein at least one of said at least two waste receptacles is free of refuse compaction units.

23. A waste receptacle system comprising:
a housing having a space defined therein in which refuse can be accumulated;
an access door mounted to said housing, said access door being movable to an open position to permit refuse to be introduced into said space;
a sensor mounted to detect the presence of accumulated refuse, said sensor being operable to indicate when the accumulated refuse has reached a full condition;
a control system operable to monitor said sensor; and
said control system being operable to signal said full condition to a person remote from said housing.

24. A waste receptacle array system, comprising:
at least a first waste receptacle, a second waste receptacle, and a remote communication device located away from said first and second receptacles;
said first waste receptacle having,
a housing having a space defined therein in which refuse can be accumulated;
an access door mounted to said housing, said access door being movable to an open position to permit refuse to be introduced into said space;
a sensor mounted to detect the presence of accumulated refuse, said sensor being operable to indicate when the accumulated refuse has reached a full condition;
a control system operable to monitor said sensor; and
said control system being operable to signal said full condition to said remote communication device located away from said housing;
said second waste receptacle having,
a housing having a space defined therein in which refuse can be accumulated;
an access door mounted to said housing, said access door being movable to an open position to permit refuse to be introduced into said space;
a sensor mounted to detect the presence of accumulated refuse, said sensor being operable to indicate when the accumulated refuse has reached a full condition;
a control system operable to monitor said sensor; and
said control system being operable to signal said full condition to said remote communication device;

25. The waste receptacle of claim 24 wherein said remote communication device is operable to notify staff of a full condition any of said first and said second receptacles.

26. The waste receptacle of claim 2 wherein said remote communication device includes at least one telephonic communication element.

27. The waste receptacle of claim 26 wherein said at least one telephonic communication element is chosen from the set of telephonic communications elements consisting of (a) a cell phone; and (b) a beeper.

28. The waste receptacle of claim 24 wherein at least one of said at least two receptacles includes a refuse compaction unit.

29. The waste receptacle of claim 24 wherein at least one of said at least two waste receptacles is free of refuse compaction units.

30. A waste receptacle comprising:
a housing having a space defined therein in which a quantity of refuse can be accumulated;
an access door mounted to said housing, said access door being movable to an open position to permit refuse to be introduced into the space;
an actuator operable to move said access door to said open position;
a controller connected to said actuator, said controller governing operation of said actuator;
a sensor mounted to detect the presence of patrons adjacent to said access door;
said controller being operable to monitor said sensor;
said sensor having a first sensor element and a second sensor element;
said first sensor element being positioned to observe a first approach envelope relative to said access door;
said second sensor element being positioned to observe a second approach envelope relative to said access door; and
said first approach envelope and said second approach envelope taken together cover a total approach envelope greater than said first range alone, and greater than said second range alone.

31. The waste receptacle of claim 30 wherein said proximity sensor has a plurality of illumination elements, said plurality of illumination elements being co-operable to cover all of said first approach envelope.

32. The waste receptacle of claim 31 wherein said plurality of illumination elements includes at least a first illumination element oriented to cover at least a first portion of said first approach envelope of said first sensing element, and a second illumination element oriented to cover at least a second portion of said first approach envelope, said first and second portions overlapping each other.

33. The waste receptacle of claim 30 wherein said first sensing element and said second sensing element are mounted on a common base, and are spaced apart from each other on said base.

34. The waste receptacle of claim 30 wherein:
said first sensing element and said second sensing element are mounted to a common base;
said first sensing element is oriented at a first angle relative to said base; and
said second element is oriented at a different angle relative to said base.

35. The waste receptacle of claim 30 wherein said sensor has a base, and a vertical plane of symmetry of said base extends normal to said base away from said waste receptacle, and said first approach envelope lies at least predominantly to one side of said plane, and said second approach envelope lies predominantly to the other side of said plane.

36. The waste receptacle of claim 30 wherein said first and second approach envelopes overlap.

37. The waste receptacle of claim 30 wherein said sensor includes at least two illumination elements placed to co-operate with said first sensing element.

38. The receptacle of claim 30 wherein each of said first and second approach envelopes is illuminated, at least in part, by more than one illumination element.

39. The receptacle of claim 30 wherein said sensor is an infra red proximity sensor.

40. The receptacle of claim 30 wherein said sensor includes infra red light emitting diodes and said first and second approach envelopes are illuminated by said light emitting diodes.

41. A waste receptacle comprising:
a housing having a space defined therein in which refuse can be accumulated;
said housing having a first panel, said first panel having an opening formed therein through which refuse can be introduced into the space;
an access door mounted to said first panel, said access door being movable to an open position to permit refuse to be introduced into said space;
said housing and said access door mating along respective straight edges and being joined by a hinge running parallel to said straight edges;
said panel having a first inner face and a first outer face;
said access door having a second inner face and a second outer face;
said hinge having first and second wings mounted to said first and second inner faces of said panel and said door respectively;
said hinge having a hinge pin;
each of said first and second hinge pins having tabs bent about said pin;
said hinge pin being mounted adjacent to said first and second outer faces of said panel and said access door respectively.

42. The waste receptacle of claim 41 wherein said tabs are formed on a circular arc to engage said pin, and said tabs have an outer radius, said first and second outer surfaces lie in a plane when said access door is closed; and said tabs lie tangent to said plane.

43. The waste receptacle of claim 41 wherein at least one of (a) said panel and (b) said access door, is inwardly relieve to accommodate pivoting motion of said access door about said hinge to an open position.

44. The waste receptacle of claim 41 wherein at least one of (a) said panel, and (b) said access door, is chamfered to accommodate opening motion of said door relative to said panel.

45. The waste receptacle of claim 41 wherein at least one of (a) said first wing and (b) said second wing of said hinge has a proximal portion adjacent said hinge and a distal portion lying away from said hinge, said proximal portion being joined to said distal portion at a bend.

46. The waste receptacle of claim 45 wherein said bend is a dog leg formed to seat said first proximal portion and said distal portion about a chamfer.

47. The waste receptacle of claim 41 wherein said hinge is a continuous hinge extending along the majority of the length of the respective straight edges.

48. The waste receptacle of claim 41 wherein the hinge pin has a pivot axis and said axis lies closer to said outer face of said panel than to said inner face.

49. The waste receptacle of claim 41 wherein, in said closed position of said door said proximal portion of said first wing and said proximal portion of said second wing are oriented at an acute included angle [alpha] from each other, and as said access door is moved to an open position said included angle diminishes.

50. The waste receptacle of claim 41 wherein, in said closed position of said access door, said proximal portion of said first wing of said hinge lies in a first plane, said proximal portion of said second wing lies in a second plane, said first and second planes intersecting along a line of intersection, said hinge pin having a pivot axis, and, said line of intersection lies further from said inner face of said first panel than said hinge pin axis.

51. The waste receptacle of claim 41 wherein said line of intersection of said first and second planes moves further away from said hinge pin axis as said access door is opened.
